(19) United States
(12) Patent Application Publication
(10) Pub. No.: US 2024/0079723 A1
(43) Pub. Date: Mar. 7, 2024

(54) POLYOLEFIN MICROPOROUS MEMBRANE

(71) Applicant: Asahi Kasei Kabushiki Kaisha, Tokyo (JP)

(72) Inventors: Wataru Mizutani, Tokyo (JP); Tomosato Okubo, Tokyo (JP); Masaaki Okada, Tokyo (JP); Takeshi Matsubayashi, Tokyo (JP)

(73) Assignee: Asahi Kasei Kabushiki Kaisha, Tokyo (JP)

(21) Appl. No.: 18/139,404

(22) Filed: Apr. 26, 2023

(30) Foreign Application Priority Data
Apr. 28, 2022 (JP) 2022-075126
Apr. 24, 2023 (JP) 2023-071085

(51) Int. Cl. H01M 50/417; H01M 50/451; H01M 50/457; H01M 50/491; H01M 50/494

(52) U.S. Cl. CPC H01M 50/417; H01M 50/451; H01M 50/457; H01M 50/491; H01M 50/494

(57) ABSTRACT

A polyolefin microporous membrane having a film thickness of 1 μm to 30 μm; an air permeability of 500 sec/100 cm³ or less; and a withstand voltage reduction rate of 1.0% or greater and 17.0% or less due to pressing under conditions of a temperature of 60° C., a pressure of 3.4 MPa, and a compression time of 1 sec or a withstand voltage reduction rate of 1.0% or greater and 28.0% or less due to pressing under conditions of a temperature of 70° C., a pressure of 8 MPa, and a compression time of 3 min, or having a polyethylene crystal long period before compression of 35.0 nm or more, measured by a small-angle X-ray scattering (SAXS) method, and a diffraction peak-to-peak distance of 2.410° or more and 2.600° or less derived from a (110) plane and a (200) plane of a polyethylene crystal before compression is provided.

### FIELD

The present invention relates to a polyolefin microporous membrane.

### BACKGROUND

Polyolefin microporous membranes exhibit excellent electrical insulation property and ion permeability, and are thus used in separators for cells, separators for capacitors, materials for fuel cells, and microfiltration membranes. In particular, polyolefin microporous membranes are used as separators for lithium-ion secondary cells.

In recent years, lithium-ion secondary cells are used in both small electronic devices, such as mobile phones and notebook computers, and electrically driven vehicles, such as electric cars and small electric motorcycles. The separators for lithium-ion secondary cells are required to have not only mechanical properties and ion permeability, but also safety in various safety tests. Compression test characteristics of separators for lithium-ion secondary cells have also been examined (PTL 1).

PTL 1 reports that an inorganic coating layer is provided on a polyolefin microporous membrane acting as a separator substrate and inorganic particles are uniformly dispersed in the inorganic coating layer, whereby the withstand voltage change rate is adjusted when the separator is pressed and local crushing is inhibited.

### CITATION LIST

### Patent Literature

[PTL 1] WO 2021/101222

### SUMMARY

### Technical Problem

Nonaqueous secondary cells such as lithium-ion secondary cells have evolved into various shapes, such as cylindrical, prismatic, and pouch type, in accordance with the application thereof. The method of manufacturing a cell varies depending on the shape of the cell. For example, in the manufacture of a prismatic cell, there is a step wherein a wound or laminated body of electrodes and a polyolefin membrane is pressed and inserted into a rectangular exterior can.

However, because of membrane crushing and withstand voltage reduction associated with the pressing in a cell production step using a conventional separator as described in PTL 1 and pressing due to electrode expansion inside a cell, achieving high output and high cycle characteristics of the cell and inhibition of short-circuit defects has been difficult.

In view of the above circumstances, an object of the present invention is to provide a polyolefin microporous membrane capable of achieving high output and high cycle characteristics of a nonaqueous secondary cell and inhibition of short-circuit defects, as well as a separator for nonaqueous secondary cells and a nonaqueous secondary cell comprising the same.

### Solution to Problem

The present inventors have discovered that the above object can be achieved by specifying the withstand voltage reduction rate due to pressing under predetermined conditions and the crystal structure in a polyolefin microporous membrane before compression, and have completed the present invention. The embodiment of the present invention is exemplified below.

<1>

A polyolefin microporous membrane having a film thickness of 1 μm to 30 μm; an air permeability of 500 sec/100 cm³ or less; and a withstand voltage reduction rate of 1.0% or greater and 17.0% or less due to pressing under conditions of a temperature of 60° C., a pressure of 3.4 MPa, and a compression time of 1 sec.

<2>

A polyolefin microporous membrane having a film thickness of 1 μm to 30 μm; an air permeability of 500 sec/100 cm³ or less; and a withstand voltage reduction rate of 1.0% or greater and 28.0% or less due to pressing under conditions of a temperature of 70° C., a pressure of 8 MPa, and a compression time of 3 min.

<3>

A polyolefin microporous membrane having a polyethylene crystal long period before compression of 35.0 nm or more, measured by a small-angle X-ray scattering (SAXS) method; and a diffraction peak-to-peak distance of 2.410° or more and 2.600° or less derived from a (110) plane and a (200) plane of a polyethylene crystal before compression.

<4>

The polyolefin microporous membrane according to any one of items 1 to 3, wherein the polyolefin microporous membrane before compression has a porosity of 40% or greater and 80% or less and a basis weight equivalent puncture strength of 55 gf/(g/m²) or more and 150 gf/(g/m²) or less.

<5>

The polyolefin microporous membrane according to any one of items 1 to 4, wherein an average of dynamic friction coefficients on both surfaces of the polyolefin microporous membrane is 0.01 or greater and 0.4 or less.

<6>

The polyolefin microporous membrane according to any one of items 1 to 5, wherein the polyolefin microporous membrane has a melt flow index (MI) value of 0.01 g/10 min or more and 0.50 g/10 min or less.

<7>

The polyolefin microporous membrane according to any one of items 1 to 6, wherein a ratio (MD/TD tensile strength ratio) of a tensile strength in longitudinal direction (MD) to a tensile strength in width direction (TD) of the polyolefin microporous membrane is 0.7 to 1.3.

<8>

A separator comprising:
the polyolefin microporous membrane according to any one of items 1 to 7; and
an inorganic porous layer arranged on at least one side of the polyolefin microporous membrane.
   <9>

A separator comprising:
the polyolefin microporous membrane according to any one of items 1 to 7; and
a thermoplastic resin layer arranged on at least one side of the polyolefin microporous membrane.
   <10>

A separator comprising:
the polyolefin microporous membrane according to any one of items 1 to 7; and
at least one layer selected from the group consisting of a multifunctional layer, an inorganic porous layer, and a thermoplastic resin layer, arranged on at least one side of the polyolefin microporous membrane.
   <11>

A nonaqueous secondary cell comprising the separator according to any one of items 8 to 10.

### Advantageous Effects of Invention

According to the present invention, high output and high cycle characteristics of a nonaqueous secondary cell comprising a polyolefin microporous membrane and inhibition of short-circuit defects can be achieved.

### DESCRIPTION OF EMBODIMENTS

Hereinafter, aspects embodying the present invention (hereinafter, shortened as “embodiments”) will be described in detail. Note that the present invention is not limited to the following embodiments, and various modifications can be made without departing from the spirit of the present invention.

Herein, longitudinal direction (MD) means machine direction of a continuous molding of a microporous membrane, and width direction (TD) means transverse direction at an angle of 90° from the MD of the microporous membrane.

In the present specification, the upper and lower limits of each numerical range can be combined arbitrarily. In addition, for a particular member to contain a specific component as a main component means that the content of the specific component is 50% by weight or greater based on the weight of the member. Unless specified otherwise, physical properties and numerical values described herein are measured or calculated by methods described in the Examples.

### <Polyolefin Microporous Membrane>

One aspect of the present invention is a polyolefin microporous membrane. The polyolefin microporous membrane comprises a polyolefin resin as a main component and can exhibit excellent electrical insulation property and ion permeability, and thus can be used in, for example, nonaqueous secondary cells, specifically as a separator for nonaqueous secondary cells.

### Embodiment 1

The polyolefin microporous membrane according to Embodiment 1 has the following features:
a film thickness of 1 μm to 30 μm;
an air permeability of 500 sec/100 cm³ or less; and
a withstand voltage reduction rate of 1.0% or greater and 17.0% or less due to pressing under conditions of a temperature of 60° C., a pressure of 3.4 MPa, and a compression time of 1 sec.

In the polyolefin microporous membrane according to Embodiment 1, by having a film thickness in the range of 1 μm to 30 μm; an air permeability of 500 sec/100 cm³ or less; and a withstand voltage reduction rate of 1.0% or greater and 17.0% or less under relatively mild pressing conditions of a temperature of 60° C., a pressure of 3.4 MPa, and a compression time of 1 sec, not only can the compression resistance of the membrane be increased, but by also optimizing the crystal structure, high output and high cycle characteristics and inhibition of short-circuit defects can be achieved. The withstand voltage change from the polyolefin microporous membrane according to Embodiment 1 due to crushing of the membrane and change in crystal structure is remarkable when an electrode that easily expands and contracts within a nonaqueous secondary cell is used, and is more remarkable when a high-capacity electrode used in automotive cells or a silicon (Si)-containing negative electrode is used.

A method for carrying out a compression test by pressing under conditions of a temperature of 60° C., a pressure of 3.4 MPa, and a compression time of 1 sec will be described in detail in the Examples. It is considered that the withstand voltage reduction rate is associated with the structure of the main component of the polyolefin microporous membrane that improves output and cycle characteristics and/or inhibits short-circuit defects in a nonaqueous secondary cell.

The lower limit value of the withstand voltage reduction rate of the polyolefin microporous membrane due to pressing under conditions of a temperature of 60° C., a pressure of 3.4 MPa, and a compression time of 1 sec, from the viewpoint described above, is preferably 1.0% or greater, more preferably 5.0% or greater, even more preferably 6.0% or greater, still more preferably 7.0% or greater, and particularly preferably 10.0% or greater. The upper limit value thereof is preferably 17.0% or less, more preferably 16.0% or less, even more preferably 15.5% or less, and particularly preferably 15.0% or less.

The withstand voltage reduction rate of the polyolefin microporous membrane due to pressing under conditions of a temperature of 60° C., a pressure of 3.4 MPa, and a compression time of 1 sec can be adjusted to within the numerical ranges described above by controlling, for example, the molecular weight of the polyolefin or polyethylene raw material, content of the polyethylene raw material, stretch ratio during the biaxial stretching step, MD/TD stretching temperature during the biaxial stretching step, temperature during the heat setting step, or ratio (preheating coefficient/heat setting coefficient) of the preheating coefficient relative to the heat setting coefficient in a heat setting furnace during the heat setting step in a manufacturing process of the polyolefin microporous membrane. From the viewpoint of adjusting the withstand voltage reduction rate by reducing changes in the polyolefin microporous membrane crystals due to pressing in the production of a nonaqueous secondary cell, it is preferable to set the molecular weight of the polyolefin or polyethylene raw material, the content of the polyethylene raw material, the stretch ratio during the biaxial stretching step, the MD/TD stretching temperature during the biaxial stretching step, and the temperature during the heat setting (HS) step relatively high, and/or the ratio (preheating coefficient/heat setting coefficient) in the heat setting furnace below or equal to a constant value, specifically 0.5 or less.

A comparison of the withstand voltage values or withstand voltage properties before and after a compression test for the polyolefin microporous membrane according to Embodiment 1 is preferable from the viewpoint of specifying the structure of the main component of the polyolefin microporous membrane which can achieve high output and high cycle characteristics of a nonaqueous secondary cell and inhibition of short-circuit defects. The withstand voltage values or withstand voltage properties before the compression test and of the polyolefin microporous membrane not subjected to a compression test are measured by the method described in the Examples.

From the viewpoint of miniaturization in addition to achieving high output and high cycle characteristics and inhibition of short-circuit defects, the lower limit value of the film thickness of the polyolefin microporous membrane according to Embodiment 1 is 1 μm or more, preferably 3 μm or more, more preferably 4 μm or more, even more preferably 5 μm or more, and particularly preferably 8 μm or more. The upper limit value thereof is 30 μm or less, preferably 25 μm or less, more preferably 20 μm or less, even more preferably 16 μm or less, still more preferably 15 μm or less, and particularly preferably 13 μm or less. The film thickness of the microporous membrane can be optimized by, for example, the roll-to-roll distance between cast rolls or the stretch ratio in the stretching step.

The air permeability of the polyolefin microporous membrane according to Embodiment 1 can be measured by the method described in the Examples before a compression test. The air permeability of the polyolefin microporous membrane according to Embodiment 1, from the viewpoints of ion permeability of the microporous membrane and higher output of the nonaqueous secondary cell in addition to achieving high output and high cycle characteristics and inhibition of short-circuit defects, is 500 sec/100 cm³ or less, preferably 200 sec/100 cm³ or less, more preferably 150 sec/100 cm³ or less, even more preferably 130 sec/100 cm³ or less, still more preferably 120 sec/100 cm³ or less, particularly preferably 110 sec/100 cm³ or less, especially preferably 100 sec/100 cm³ or less, and most preferably 90 sec/100 cm³ or less, and from the viewpoint of mechanical strength of the microporous membrane, is preferably 10 sec/100 cm³ or more, more preferably 40 sec/100 cm³ or more, even more preferably 50 sec/100 cm³ or more, still more preferably 60 sec/100 cm³ or more, particularly preferably 70 sec/100 cm³ or more, and most preferably 80 sec/100 cm³ or more. The air permeability of the microporous membrane can be similarly optimized with the control means for the withstand voltage reduction rate described above.

### Embodiment 2

The polyolefin microporous membrane according to Embodiment 2 has the following features:
a film thickness of 1 μm to 30 μm;
an air permeability of 500 sec/100 cm³ or less; and
a withstand voltage reduction rate of 1.0% or greater and 28.0% or less due to pressing under conditions of a temperature of 70° C., a pressure of 8 MPa, and a compression time of 3 min.

In the polyolefin microporous membrane according to Embodiment 2, by having a film thickness in the range of 1 μm to 30 μm; an air permeability of 500 sec/100 cm³ or less; and a withstand voltage reduction rate of 1.0% or greater and 28.0% or less under relatively intense pressing conditions of a temperature of 70° C., a pressure of 8 MPa, and a compression time of 3 min, not only can the compression resistance of the membrane be increased, but also a large amount of unstable crystal structures can be contained in the membrane. For example, in the production of a nonaqueous secondary cell using the polyolefin microporous membrane as a separator, the orthorhombic to monoclinic transition due to pressing is inhibited, the crushing of the membrane due to plastic deformation of the crystal structure is inhibited, and high output and high cycle characteristics of a nonaqueous secondary cell and inhibition of short-circuit defects can be achieved. The inhibition of orthorhombic to monoclinic transition during pressing by the polyolefin microporous membrane according to Embodiment 2 is remarkable when an electrode that easily expands and contracts within a nonaqueous secondary cell is used, and is more remarkable when a high-capacity electrode used in automotive cells or a silicon (Si)-containing negative electrode is used.

A method for carrying out a compression test by pressing under conditions of a temperature of 70° C., a pressure of 8 MPa, and a compression time of 3 min will be described in detail in the Examples. It is considered that the withstand voltage reduction rate is associated with the structure of the main component of the polyolefin microporous membrane that improves output and cycle characteristics and/or inhibits short-circuit defects in a nonaqueous secondary cell.

The lower limit value of the withstand voltage reduction rate of the polyolefin microporous membrane due to pressing under conditions of a temperature of 70° C., a pressure of 8 MPa, and a compression time of 3 min, from the viewpoint described above, is preferably 1.0% or greater, more preferably 5.0% or greater, even more preferably 10.0% or greater, and particularly preferably 15.0% or greater. The upper limit value thereof is preferably 28.0% or less, more preferably 25.0% or less, even more preferably 23.0% or less, and particularly preferably 20.0% or less.

The withstand voltage reduction rate of the polyolefin microporous membrane due to pressing under conditions of a temperature of 70° C., a pressure of 8 MPa, and a compression time of 3 min can be adjusted to within the numerical ranges described above by controlling, for example, the molecular weight of the polyolefin or polyethylene raw material, content of the polyethylene raw material, stretch ratio during the biaxial stretching step, MD/TD stretching temperature during the biaxial stretching step, the temperature during the heat setting step, or ratio (preheating coefficient/heat setting coefficient) of the preheating coefficient relative to the heat setting coefficient in a heat setting furnace during the heat setting step in a manufacturing process of the polyolefin microporous membrane. From the viewpoint of adjusting the withstand voltage reduction rate by reducing changes in the polyolefin microporous membrane crystals due to pressing in the production of a nonaqueous secondary cell, it is preferable to set the molecular weight of the polyolefin or polyethylene raw material, the content of the polyethylene raw material, the stretch ratio during the biaxial stretching step, the MD/TD stretching temperature during the biaxial stretching step, and the temperature during the HS step relatively high, and/or the ratio (preheating coefficient/heat setting coefficient) in the heat setting furnace below or equal to a constant value, specifically 0.5 or less.

A comparison of the withstand voltage values or withstand voltage properties before and after a compression test for the polyolefin microporous membrane according to Embodiment 2 is preferable from the viewpoint of specifying the structure of the main component of the polyolefin microporous membrane which can achieve high output and high cycle characteristics of a nonaqueous secondary cell and inhibition of short-circuit defects. The withstand voltage values or withstand voltage properties before the compression test and of the polyolefin microporous membrane not subjected to a compression test are measured by the method described in the Examples.

From the viewpoint of miniaturization in addition to achieving high output and high cycle characteristics and inhibition of short-circuit defects, the lower limit value of the film thickness of the polyolefin microporous membrane according to Embodiment 2 is 1 μm or more, preferably 3 μm or more, more preferably 4 μm or more, even more preferably 5 μm or more, and particularly preferably 8 μm or more. The upper limit value thereof is 30 μm or less, preferably 25 μm or less, more preferably 20 μm or less, even more preferably 16 μm or less, still more preferably 15 μm or less, and particularly preferably 13 μm or less. The film thickness of the microporous membrane can be optimized by, for example, the roll-to-roll distance between cast rolls or the stretch ratio in the stretching step.

The air permeability of the polyolefin microporous membrane according to Embodiment 2 can be measured by the method described in the Examples before a compression test. The air permeability of the polyolefin microporous membrane according to Embodiment 2, from the viewpoints of ion permeability of the microporous membrane and higher output of the nonaqueous secondary cell in addition to achieving high output and high cycle characteristics and inhibition of short-circuit defects, is 500 sec/100 cm³ or less, preferably 200 sec/100 cm³ or less, more preferably 150 sec/100 cm³ or less, even more preferably 130 sec/100 cm³ or less, still more preferably 120 sec/100 cm³ or less, particularly preferably 110 sec/100 cm³ or less, especially preferably 100 sec/100 cm³ or less, and most preferably 90 sec/100 cm³ or less, and from the viewpoint of mechanical strength of the microporous membrane, is preferably 10 sec/100 cm³ or more, more preferably 40 sec/100 cm³ or more, even more preferably 50 sec/100 cm³ or more, still more preferably 60 sec/100 cm³ or more, particularly preferably 70 sec/100 cm³ or more, and most preferably 80 sec/100 cm³ or more. The air permeability of the microporous membrane can be similarly optimized with the control means for the withstand voltage reduction rate described above.

### Embodiment 3

The polyolefin microporous membrane according to Embodiment 3 has the following features:
The polyolefin microporous membrane has a polyethylene crystal long period before compression of 35.0 nm or more, measured by a small-angle X-ray scattering (SAXS) method; and
the polyolefin microporous membrane has a diffraction peak-to-peak distance of 2.410° or more and 2.600° or less derived from a (110) plane and a (200) plane of a polyethylene crystal before compression.

In the polyolefin microporous membrane according to Embodiment 3, by having a polyethylene crystal long period before compression of 35.0 nm or more, measured by a small-angle X-ray scattering (SAXS) method, and a diffraction peak-to-peak distance of 2.410° or more and 2.600° or less derived from a (110) plane and a (200) plane of a polyethylene crystal before compression, surprisingly, for example, in the production of a nonaqueous secondary cell using a polyolefin microporous membrane as a separator, there is little change in crystal structure due to pressing, crushing is inhibited, withstand voltage property after pressing can be improved, and high output and cycle characteristics of a nonaqueous secondary cell and inhibition of short-circuit defects can both be achieved. The structure and the withstand voltage property after pressing of the polyolefin microporous membrane according to Embodiment 3 are remarkable when an electrode that easily expands and contracts within a nonaqueous secondary cell is used, and are more remarkable when a high-capacity electrode used in automotive cells or a silicon (Si)-containing negative electrode is used.

Measurement of the crystal long period before compression of the polyolefin microporous membrane will be described in detail in the Examples. The crystal long period before compression of the polyolefin microporous membrane according to Embodiment 3, from the viewpoint described above, is 35.0 nm or more, preferably 35.5 nm or more, more preferably 36.0 nm or more, even more preferably 36.5 nm or more, and most preferably 37.0 nm or more. In addition, the crystal long period before compression is preferably 60.0 nm or less, more preferably 50.0 nm or less, even more preferably 45.0 nm or less, and particularly preferably 40.0 nm or less.

The diffraction peak-to-peak distance derived from a (110) plane and a (200) plane of a polyethylene crystal before compression, from the same viewpoint as above, is 2.410° or more, preferably 2.415° or more, more preferably 2.420° or more, and even more preferably 2.422° or more. The upper limit value of the diffraction peak-to-peak distance is 2.600° or less, preferably 2.500° or less, more preferably 2.450° or less, and even more preferably 2.430° or less.

The polyethylene crystal long period before compression and the diffraction peak-to-peak distance derived from a (110) plane and a (200) plane of a polyethylene crystal before compression of the polyolefin microporous membrane according to Embodiment 3 can be adjusted to within the numerical ranges described above by controlling, for example, the molecular weight of the polyolefin or polyethylene raw material, content of the polyethylene raw material, stretch ratio during the biaxial stretching step, MD/TD stretching temperature during the biaxial stretching step, temperature during the heat setting step, or ratio (preheating coefficient/heat setting coefficient) of the preheating coefficient relative to the heat setting coefficient in a heat setting furnace during the heat setting step in a manufacturing process of the polyolefin microporous membrane. From the viewpoint of adjusting the withstand voltage reduction rate by reducing changes in the polyolefin microporous membrane crystals due to pressing in the production of a nonaqueous secondary cell, it is preferable to set the molecular weight of the polyolefin or polyethylene raw material, the content of the polyethylene raw material, the stretch ratio during the biaxial stretching step, the MD/TD stretching temperature during the biaxial stretching step, and the temperature during the HS step relatively high, and/or the ratio (preheating coefficient/heat setting coefficient) in the heat setting furnace below or equal to a constant value, specifically 0.5 or less.

### Embodiment 4

A polyolefin microporous membrane in which any two or more of the configurations according to Embodiment 1 to Embodiment 3 are combined is provided in Embodiment 4. The polyolefin microporous membrane according to Embodiment 4 comprises an olefin as a main component and has a thickness of 1 μm to 30 μm; an air permeability (before compression) of 500 sec/100 cm³ or less; a withstand voltage reduction rate of 1.0% or greater and 17.0% or less due to pressing under conditions of a temperature of 60° C., a pressure of 3.4 MPa, and a compression time of 1 sec and/or a withstand voltage reduction rate of 1.0% or greater and 28.0% or less due to pressing under conditions of a temperature of 70° C., a pressure of 8 MPa, and a compression time of 3 min; and a polyethylene crystal long period before compression of 35.0 nm or more, measured by a small-angle X-ray scattering (SAXS) method, and/or a diffraction peak-to-peak distance of 2.410° or more and 2.600° or less derived from a (110) plane and a (200) plane of a polyethylene crystal before compression.

The common components, preferable components, and additional components in Embodiments 1 to 4 will be described hereinafter.

### (Component)

Examples of the polyolefin microporous membrane include porous membranes comprising a polyolefin resin; porous membranes comprising resins other than polyolefin resins, such as poly ethylene terephthalate, polycycloolefin, poly ethers ulfone, poly amide, polyimide, polyimideamide, polyaramid, polycycloolefin, nylon, and polytetrafluoroethylene; materials (woven fabrics) woven from polyolefin-based fibers; and nonwoven fabrics of polyolefin-based fibers. Of these, from the viewpoints of inhibition of decrease or increase in electrical resistance of the membrane and compression resistance and structural uniformity of the membrane, a microporous membrane comprising a polyolefin resin (hereinafter referred to as a polyolefin resin porous membrane) is preferable, and a microporous membrane comprising polyethylene as a main component is more preferable.

The polyolefin resin porous membrane will be described. The polyolefin resin porous membrane, from the viewpoint of improving shutdown performance when forming a polyolefin microporous membrane for nonaqueous secondary cells, is preferably a porous membrane formed of a polyolefin resin composition in which a polyolefin resin accounts for 50% by weight or greater and 100% by weight or less of the resin component constituting the porous membrane. The ratio of the polyolefin resin in the polyolefin resin composition is more preferably 60% by weight or greater and 100% by weight or less, even more preferably 70% by weight or greater and 100% by weight or less, and most preferably 95% by weight or greater and 100% by weight or less.

Examples of the polyolefin resin contained in the polyolefin resin composition include, but are not particularly limited to, homopolymers which can be used as monomers, such as ethylene, propylene, 1-butene, 4-methyl-1-pentene, 1-hexene, and 1-octene; copolymers; and multistage polymers. These polyolefin resins may be used alone or in a mixture of two or more.

Of these, from the viewpoints of inhibition of decrease or increase in electrical resistance of the membrane and compression resistance and structural uniformity of the membrane, the polyolefin resin is preferably polyethylene, polypropylene, an ethylene-propylene copolymer, a copolymer of ethylene-propylene-another monomer, or a mixture thereof.

Specific examples of the polyethylene include low-density polyethylene, linear low-density polyethylene, medium-density polyethylene, high-density polyethylene, and ultra-high-density polyethylene. Specific examples of the polypropylene include isotactic polypropylene, syndiotactic polypropylene, and atactic polypropylene. Specific examples of the copolymer include ethylene-propylene copolymers and ethylene propylene rubbers.

The polyolefin resin membrane, from the viewpoints of crystallinity when forming a polyolefin microporous membrane for nonaqueous secondary cells, high strength, and compression resistance, is preferably a porous membrane formed of a polyethylene composition in which polyethylene accounts for 50% by weight or greater and 100% by weight or less of the resin component constituting the microporous membrane. The ratio of polyethylene in the resin component constituting the porous membrane is more preferably 60% by weight or greater and 100% by weight or less, even more preferably 70% by weight or greater and 100% by weight or less, and most preferably 90% by weight or greater and 100% by weight or less.

For the polyolefin resin contained in the polyolefin resin porous membrane, from the viewpoint of stiffening the membrane to improve compression resistance, the melting point is preferably 120° C. or higher and 150° C. or lower and more preferably in the range of 125° C. or higher and 140° C. or lower, and/or the DSC 1^{st} peak temperature is preferably in the range of 136° C. to 144° C.

From the viewpoints of crystallinity when forming a polyolefin microporous membrane as a separator for nonaqueous secondary cells, high strength, compression resistance, and inhibition of electrical resistance, the ratio of polyethylene in the polyolefin resin is preferably 30% by weight or greater, more preferably 50% by weight or greater, even more preferably 70% by weight or greater, and particularly preferably 80% by weight or greater, and preferably 100% by weight or less, more preferably 97% by weight or less, and even more preferably 95% by weight or less. It is preferable that the ratio of polyethylene (PE) in the polyolefin resin be 100% by weight from the viewpoint of exhibiting strength. It is also preferable that the ratio of PE in the polyolefin resin be 50% or greater from the viewpoint of exhibiting fuse behavior with high responsiveness.

Optional additives can be contained in the polyolefin resin composition. Examples of the additive include polymers other than polyolefin resins; inorganic fillers; phenol-based, phosphorus-based, and sulfur-based antioxidants; metal soaps such as calcium stearate and zinc stearate; ultraviolet absorbents; photostabilizers; antistatic agents; antifogging agents; and coloring pigments. The addition amount of these additives relative to 100% by weight of the polyolefin resin is preferably 20% by weight or less from the viewpoint of improving shutdown performance, more preferably 10% by weight or less, and even more preferably 5% by weight or less.

When the porous membrane is a polyolefin resin porous membrane, the viscosity-average molecular weight (Mv) of the polyolefin resin used as a raw material is preferably 30,000 or greater and 6,000,000 or less, more preferably 80,000 or greater and 3,000,000 or less, and even more preferably 150,000 or greater and 2,000,000 or less. It is preferable that the viscosity-average molecular weight be 30,000 or greater since entanglement of polymers tends to result in higher strength. It is also preferable that the viscosity-average molecular weight be 6,000,000 or less from the viewpoint of improving moldability in the extrusion and stretching steps.

When the polyolefin resin porous membrane comprises polyethylene as a main component, the Mv of at least one type of polyethylene, from the viewpoint of orientation and rigidity of the membrane, is preferably 500,000 or greater, more preferably 600,000 or greater, even more preferably 700,000 or greater, and still more preferably 800,000 or greater. The My upper limit value of the polyethylene may be, for example, 2,000,000 or less. From the same viewpoint, the ratio of polyethylene having My of 700,000 or greater in the polyolefin resin constituting the polyolefin resin porous membrane is preferably 50% by weight or greater, more preferably 60% by weight or greater, even more preferably 70% by weight or greater, and particularly preferably 80% by weight or greater, and may be 100% by weight.

The polyolefin resin porous membrane may optionally comprise polypropylene. The ratio of polypropylene in the polyolefin resin may be, for example, greater than 0% by weight, or may be in the range of 1% by weight to 10% by weight or in the range of 5% by weight to 8% by weight.

The type, molecular weight, and composition of the polyolefin resin constituting the polyolefin resin porous membrane can be adjusted as described above by controlling, for example, the type, molecular weight, and blending ratio of a polymer raw material such as a polyolefin in a manufacturing process of the polyolefin microporous membrane. In addition, a multilayer polyolefin resin microporous membrane having a structure in which two or more layers of the same or different polyolefin resin microporous membranes are laminated is prepared as described above.

### (Details of Microporous Membrane)

The polyolefin microporous membrane has a porous structure in which a large number of very small pores accumulate to form dense interconnecting pores, and thus simultaneously has superior ion permeability and high strength when an electrolyte is contained therein.

The average film thickness of the polyolefin microporous membrane (before compression), from the viewpoint of contributing to improvement of cell capacity by reducing the volume taken by a separator in addition to achieving high output and high cycle characteristics and inhibition of short-circuit defects, the lower limit value is 1 μm or more, preferably 3 μm or more, more preferably 4 μm or more, even more preferably 5 μm or more, and particularly preferably 8 μm or more. The upper limit value thereof is 30 μm or less, preferably 25 μm or less, more preferably 20 μm or less, even more preferably 16 μm or less, still more preferably 15 μm or less, and particularly preferably 13 μm or less. The average film thickness of the polyolefin microporous membrane can be adjusted to within the above numerical ranges by controlling the roll-to-roll distance between cast rolls, cast clearance, stretch ratio during the biaxial stretching step, HS ratio, and HS temperature.

For example, from the viewpoint of decreasing electrical resistance of the membrane after the pressing step in the manufacture of a nonaqueous secondary cell to achieve both high output and high cycle characteristics of the cell and from the viewpoint of high ion permeability and puncture strength, the lower limit value of the air permeability of the polyolefin microporous membrane (before compression) is preferably 10 sec/100 cm³ or more, more preferably 40 sec/100 cm³ or more, even more preferably 50 sec/100 cm³ or more, still more preferably 60 sec/100 cm³ or more, particularly preferably 70 sec/100 cm³ or more, and most preferably 80 sec/100 cm³ or more. The upper limit value thereof is preferably 500 sec/100 cm³ or less, more preferably 200 sec/100 cm³ or less, even more preferably 150 sec/100 cm³ or less, still more preferably 130 sec/100 cm³ or less, even still more preferably 120 sec/100 cm³ or less, particularly preferably 110 sec/100 cm³ or less, especially preferably 100 sec/100 cm³ or less, and most preferably 90 sec/100 cm³ or less.

For example, from the viewpoint of decreasing electrical resistance of the membrane after the pressing step in the manufacture of a nonaqueous secondary cell comprising a microporous membrane as a separator to achieve both high output and high cycle characters of the cell, the porosity of the polyolefin microporous membrane (before compression) is preferably 40% or greater or 40.0% or greater, more preferably 41.0% or greater, even more preferably 42.0% or greater, still more preferably 43.0% or greater, particularly preferably 44.0% or greater, especially preferably 45.0% or greater, and most preferably 46.0 or greater, and from the viewpoint of cell safety and achieving a constant membrane strength and low air permeability, is preferably 80% or less or 80.0% or less, more preferably 70.0% or less, even more preferably 65.0% or less, still more preferably 60.0% or less, particularly preferably 55.0% or less, and most preferably 50.0% or less. The porosity of the microporous membrane can be adjusted by controlling the blending ratio of polyolefin resin composition and plasticizer, stretch ratio during the biaxial stretching step, stretch ratio during heat setting, relaxation rate during heat setting, or a combination thereof.

From the viewpoint of achieving high ion permeability, excellent withstand voltage, and high strength, the lower limit value of the pore size of the microporous membrane, when measured by a half-dry method, is preferably 10 nm or more, more preferably 20 nm or more, even more preferably 30 nm or more, still more preferably 40 nm or more, and particularly preferably 45 nm or more. The upper limit value thereof is preferably 100 nm or less, more preferably 80 nm or less, even more preferably 70 nm or less, still more preferably 60 nm or less, particularly preferably 55 nm or less, and most preferably 50 nm or less. The pore size of the microporous membrane can be adjusted by controlling, for example, the stretching temperature, stretch ratio, heat setting temperature, stretch ratio during heat setting, relaxation rate during heat setting, or a combination thereof.

For example, from the viewpoint of enhancing safety in a safety test such as a puncture test, the upper limit value of the melt flow index (MI) at 190° C. of the polyolefin microporous membrane is preferably 0.50 g/10 min or less, more preferably 0.45 g/10 min or less, even more preferably 0.40 g/10 min or less, and particularly preferably 0.30 g/10 min or less. The lower limit value thereof is preferably 0.01 g/10 min or more, more preferably 0.03 g/10 min or more, even more preferably 0.05 g/10 min or more, still more preferably 0.08 g/10 min or more, and particularly preferably 0.10 g/10 min or more. The MI of the polyolefin microporous membrane can be adjusted to within the above numerical ranges by controlling, for example, the average molecular weight and/or blending ratio of a polymer raw material such as polyethylene.

From the viewpoint of increasing membrane strength to inhibit crushing of the membrane during, for example, pressing and the viewpoint of high output and high cycle characteristics of the cell, the basis weight equivalent puncture strength of the polyolefin microporous membrane is preferably 55 gf/(g/m²) or more and 150 gf/(g/m²) or less. The basis weight equivalent puncture strength is measured by the method described in the Examples, and is obtained by measuring the puncture strength not converted in terms of basis weight (hereinafter, simply referred to as puncture strength) at a total of three points, two points inside 10% of total width from each of the edges toward the center and one point at the center, along the TD of the membrane and then dividing the average value thereof by the basis weight. From the viewpoint of inhibiting crushing of the membrane to further improve output and cycle characteristic of the cell, the lower limit value of the basis weight equivalent puncture strength of the polyolefin microporous membrane is more preferably 57 gf/(g/m²) or more, even more preferably 60 gf/(g/m²) or more, still more preferably 65 gf/(g/m²) or more, and particularly preferably 70 gf/(g/m²) or more. The upper limit value thereof is more preferably 130 gf/(g/m²) or less, even more preferably 120 gf/(g/m²) or less, still more preferably 110 gf/(g/m²) or less, particularly preferably 100 gf/(g/m²) or less, especially preferably 90 gf/(g/m²) or less, and most preferably 80 gf/(g/m²) or less.

From the same viewpoint as the basis weight equivalent puncture strength, the lower limit value of the puncture strength of the polyolefin microporous membrane is preferably 50 gf or more, more preferably 100 gf or more, even more preferably 200 gf or more, still more preferably 240 gf or more, particularly preferably 280 gf or more, especially preferably 300 gf or more, and most preferably 350 gf or more. The upper limit value thereof is preferably 1000 gf or less, more preferably 600 gf or less, even more preferably 500 gf or less, and particularly preferably 400 gf or less.

The puncture strength and the basis weight equivalent puncture strength of the polyolefin microporous membrane can be adjusted to within the above numerical ranges by controlling, for example, the average molecular weight and/or blending ratio of a polymer raw material such as polyethylene or the stretch ratio during the biaxial stretching step.

The basis weight of the polyolefin microporous membrane, from the viewpoint of inhibiting thermal runaway of the nonaqueous secondary cell, is preferably 3.0 g/m² or more, and from the viewpoint of increasing capacity of the cell, is preferably 10 g/m² or less. The basis weight of the polyolefin microporous membrane is more preferably 3.0 g/m² or more and 7.0 g/m² or less. The basis weight of the polyolefin microporous membrane is even more preferably 3.0 g/m² or more and 6.0 g/m² or less. By improving compression resistance, the safety of the cell can be ensured even with a lower basis weight.

From the viewpoint of ensuring strength necessary for winding and laminating electrodes and separators in the manufacturing process of a nonaqueous secondary cell, the upper limit value of the tensile strength at break of the polyolefin microporous membrane, in both the MD and the TD, is preferably 5000 kgf/cm² or less, more preferably 4500 kgf/cm² or less, even more preferably 4000 kgf/cm² or less, still more preferably 3500 kgf/cm² or less, and particularly preferably 3,000 kgf/cm² or less. The lower limit value thereof is preferably 500 kgf/cm² or more, more preferably 700 kgf/cm² or more, and even more preferably 1,000 kgf/cm² or more, 1500 kgf/cm² or more, 2000 kgf/cm² or more, or 2500 kgf/cm² or more. From the viewpoint of inhibiting heat shrinkage of the polyolefin microporous membrane, the upper limit value of the tensile strength at break of the polyolefin microporous membrane, in both the MD and the TD, is preferably less than 5000 kgf/cm².

The closer the MD and TD values of tensile strength at break of the polyolefin microporous membrane are, the more isotropic the structure and the higher the structural uniformity are, and thus the cycle characteristics of the nonaqueous secondary cell containing the polyolefin microporous membrane are enhanced. From such a viewpoint, the ratio (MD/TD tensile strength ratio) of the MD tensile strength to the TD tensile strength of the polyolefin microporous membrane is preferably 0.7 to 1.3, and more preferably 0.8 to 1.2. The MD/TD tensile strength ratio of the polyolefin microporous membrane can be adjusted to within the numerical ranges described above by controlling, for example, the simultaneous biaxial stretching during the biaxial stretching step, stretch ratio during the biaxial stretching step, or HS ratio.

From the viewpoints of high shape stability of the membrane at relatively high temperatures and inhibiting short circuits in a thermal runaway state of a nonaqueous secondary cell during a nail penetration test, the heat shrinkage rate of the polyolefin microporous membrane is preferably 5% or greater and 20% or less when measured in the MD at 120° C., and preferably 1% or greater and 25% or less when measured in the TD at 120° C.

For the surface smoothness of the polyolefin microporous membrane, from the viewpoint of output characteristics and cycle characteristics of the nonaqueous secondary cell in a pressed state, the average value of surface smoothness of one side and the other side of the polyolefin microporous membrane is preferably 20,000 sec/10 cm³ or more and 200,000 sec/10 cm³ or less, more preferably 30,000 sec/10 cm³ or more and 180,000 sec/10 cm³ or less, even more preferably 40,000 sec/10 cm³ or more and 160,000 sec/10 cm³ or less, and particularly 50,000 sec/10 cm³ or more and 140,000 sec/10 cm³ or less. When the surface smoothness is less than 20,000 sec/10 cm³, the physical distance between the polyolefin microporous membrane and the electrode material becomes non-uniform. Thus, cell reaction may be non-uniform and cycle characteristics may deteriorate. When the surface smoothness is more than 200,000 sec/10 cm³, the distance between the polyolefin microporous membrane and the electrode material decreases and gaps formed between the microporous membrane and the electrode material become smaller. Thus, uniform permeation of electrolytic solution may be inhibited and cycle characteristics may deteriorate. The surface smoothness of the polyolefin microporous membrane can be adjusted to within the numerical ranges described above by controlling, for example, the molecular weight and blending ratio of a polymer raw material such as a polyolefin, roll-to-roll distance between cast rolls, stretch ratio during the biaxial stretching step, MD/TD stretching temperature during the biaxial stretching step, heating coefficient per unit resin of the resin composition during the biaxial stretching step, HS ratio, or HS temperature.

By adjusting the dynamic friction coefficient to within a predetermined range for one surface and the other surface of the polyolefin microporous membrane, the external force from pressing is evenly transmitted to the membrane. Thus, local crushing can be inhibited, and output characteristics and cycle characteristics of the nonaqueous secondary cell can be improved. From such a viewpoint, the average dynamic friction coefficient of both surfaces of the polyolefin microporous membrane is preferably 0.01 or greater and 0.4 or less, more preferably 0.05 or greater and 0.38 or less, even more preferably 0.10 or greater and 0.35 or less, still more preferably 0.15 or greater and 0.33 or less, and particularly preferably 0.20 or greater and 0.30 or less. In the case of a coating film, the coating layer is peeled from the coating film and dynamic friction coefficient or surface smoothness of the polyolefin microporous membrane is measured.

The dynamic friction coefficients of one or both sides of the polyolefin microporous membrane and the average thereof can be adjusted to within the numerical ranges described above by controlling, for example, the molecular weight of the polyolefin or polyethylene raw material, content of the polyethylene raw material, stretch ratio during the biaxial stretching step, MD/TD stretching temperature during the biaxial stretching step, temperature during the heat setting step, or ratio (preheating coefficient/heat setting coefficient) of the preheating coefficient relative to the heat setting coefficient in a heat setting furnace during the heat setting step in a manufacturing process of the polyolefin microporous membrane. From the viewpoint of evenly transmitting an external force from pressing to the membrane to inhibit local crushing, it is preferable to set the molecular weight of the polyolefin or polyethylene raw material, the content of the polyethylene raw material, the stretch ratio during the biaxial stretching step, the MD/TD stretching temperature during the biaxial stretching step, and the temperature during the heat setting (HS) step relatively high, and/or the ratio (preheating coefficient/heat setting coefficient) in the heat setting furnace below or equal to a constant value, specifically 0.5 or less.

### (Multilayer Porous Membrane)

In one aspect of the present invention, a multilayer porous membrane comprising the polyolefin microporous membrane described above and at least one layer arranged on at least one side thereof is provided. The multilayer porous membrane can impart one or a plurality of functions to the polyolefin microporous membrane, depending on the properties of the at least one layer, and can be used as a separator for nonaqueous secondary cells.

Specifically, the multilayer porous membrane can have any of the following layer configurations 1 to 4:
layer configuration 1: comprising a polyolefin microporous membrane and an inorganic porous layer arranged on at least one side of the polyolefin microporous membrane;
layer configuration 2: comprising a polyolefin microporous membrane and a thermoplastic resin layer arranged on at least one side of the polyolefin microporous membrane;
layer configuration 3: comprising a polyolefin microporous membrane and a multifunctional layer arranged on at least one side of the polyolefin microporous membrane; and
layer configuration 4: comprising a polyolefin microporous membrane, and two or more layers selected from the group consisting of an inorganic porous layer, a thermoplastic resin layer, and a multifunctional layer arranged on at least one side of the polyolefin microporous membrane.

### (Inorganic Porous Layer)

The inorganic porous layer comprises inorganic particles and a binder polymer. The multilayer porous membrane comprising an inorganic porous layer has the pore structure of the inorganic porous layer, and thus has excellent heat shrinkage inhibition even as a thin film, while maintaining ion permeability.

The inorganic particles are not particularly limited, but are preferably of a material having high heat resistance and electrical insulation property and having electrochemical stability within the range of use of a nonaqueous secondary cell.

Examples of the material of the inorganic particles include oxide-based ceramics such as alumina, silica, titania, zirconia, magnesia, ceria, yttria, zinc oxide, and iron oxide; nitride-based ceramics such as silicon nitride, titanium nitride, and boron nitride; ceramics such as silicon carbide, calcium carbonate, magnesium sulfate, aluminum sulfate, barium sulfate, aluminum hydroxide, aluminum oxide hydroxide or boehmite, potassium titanate, talc, kaolinite, dickite, nacrite, halloysite, pyrophyllite, montmorillonite, sericite, mica, amesite, bentonite, asbestos, zeolite, calcium silicate, magnesium silicate, diatomite, and quartz sand; and glass fibers. Of these, at least one selected from the group consisting of alumina, boehmite, and barium sulfate is preferable from the viewpoint of stability within a nonaqueous secondary cell. As the boehmite, synthetic boehmite, which can reduce ionic impurities that adversely affect the characteristics of an electrochemical component, is preferable. Inorganic particles of one type may be used or inorganic particles of a plurality types may be used in combination.

Examples of the shape of the inorganic particles include tabular, scaly, polyhedral, needle-like, columnar, granular, spherical, spindle-like, and block-like shapes. A plurality of inorganic particles having the above shapes may be used in combination. Of these, a block-like shape is preferable from the viewpoint of a balance of permeability and heat resistance.

The aspect ratio of the inorganic particles is preferably 1.0 or greater and 3.0 or less, and more preferably 1.1 or greater and 2.5 or less. It is preferable that the aspect ratio be 3.0 or less from the viewpoint of inhibiting water adsorption amount of the multilayer porous membrane and capacity degradation during repeated cycles and the viewpoint of inhibiting deformation at temperatures exceeding the melting point of the PO microporous membrane.

The ratio of the inorganic particles in the inorganic porous layer is preferably 90% by weight or greater and 99% by weight or less, more preferably 91% by weight or greater and 98% by weight or less, and even more preferably 92% by weight or greater and 98% by weight or less. It is preferable that the ratio of the inorganic particles be 90% by weight or greater from the viewpoint of ion permeability and the viewpoint of inhibiting deformation at temperatures exceeding the melting point of the polyolefin microporous membrane. In addition, it is preferable that the ratio be 99% by weight or less from the viewpoint of maintaining binding strength between inorganic particles or interfacial binding strength between inorganic particles and the polyolefin microporous membrane.

The binder polymer is a material that binds a plurality of inorganic particles together in an inorganic porous layer or binds an inorganic porous layer and a polyolefin microporous membrane together. As the binder polymer type, it is preferable to use a material that is insoluble in an electrolytic solution of a nonaqueous secondary cell and electrochemically stable within the range of use of the nonaqueous secondary cell when the multilayer porous membrane is used as a separator.

Specific examples of the binder polymer include the following 1) to 7):
1) polyolefins: for example, polyethylene, polypropylene, ethylene propylene rubber, and modified polymers thereof;
2) conjugated diene polymers: for example, styrene-butadiene copolymer and hydrides thereof, acrylonitrile-butadiene copolymer and hydrides thereof, and acrylonitrile-butadiene-styrene copolymer and hydrides thereof;
3) acrylic polymers: for example, methacrylic acid ester-acrylic acid ester copolymer, styrene-acrylic acid ester copolymer, and acrylonitrile-acrylic acid ester copolymer;
4) polyvinyl alcohol-based resins: for example, polyvinyl alcohol and polyvinyl acetate;
5) fluorine-containing resins: for example, polyvinylidene fluoride, polytetrafluoroethylene, vinylidene fluoride-hexafluoropropylene-tetrafluoroethylene copolymer, and ethylene-tetrafluoroethylene copolymer;
6) cellulose derivatives: for example, ethyl cellulose, methyl cellulose, hydroxyethyl cellulose, and carboxymethyl cellulose; and
7) resins having a melting point and/or glass transition temperature of 180° C. or higher or polymers having no melting point but a decomposition temperature of 200° C. or higher: for example, polyphenylene ether, poly sulfone, poly ethersulfone, polyphenylene sulfide, polyetherimide, polyamideimide, polyamide, and polyester.

From the viewpoint of safety during a short circuit, 3) acrylic polymers, 5) fluorine-containing resins, or 7) polyamides as polymers are preferable. As the polyamide, a wholly aromatic polyamide, especially polymetaphenylene isophthalamide, is suitable from the viewpoint of durability.

From the viewpoint of compatibility between a binder polymer and an electrode, the above 2) conjugated diene polymers are preferable, and from the viewpoint of withstand voltage property, the above 3) acrylic polymers and 5) fluorine-containing resins are preferable.

The above 2) conjugated diene polymers are polymers comprising a conjugated diene compound as a monomer unit.

Examples of the conjugated diene polymer include 1,3-butadiene, 2-methyl-1,3-butadiene, 2,3-dimethyl-1,3-butadiene, 2-chloro-1,3-butadiene, substituted linear conjugated pentadienes, and substituted and branched conjugated hexadienes. These may be used alone or in combination of two or more. Of these, 1,3-butadiene is particularly preferable.

The above 3) acrylic polymers are polymers comprising a (meth)acrylic compound as a monomer unit. The above (meth)acrylic compound represents at least one selected from the group consisting of (meth)acrylic acid and (meth)acrylic acid ester.

Examples of the (meth)acrylic acid used in the above 3) acrylic polymers can include acrylic acid and methacrylic acid.

Examples of the (meth)acrylic acid ester used in the above 3) acrylic polymers include (meth)acrylic acid alkyl esters, such as methyl acrylate, methyl methacrylate, ethyl acrylate, ethyl methacrylate, butyl acrylate, butyl methacrylate, 2-ethylhexyl acrylate, and 2-ethylhexyl methacrylate; and epoxy group-containing (meth)acrylic acid esters, such as glycidyl acrylate and glycidyl methacrylate. These may be used alone or in combination of two or more. Of the above, 2-ethylhexyl acrylate (EHA) and butyl acrylate (BA) are particularly preferable.

The acrylic polymer is preferably a polymer comprising EHA or BA as a main constituting unit, from the viewpoint of safety of the nonaqueous secondary cell. The main constituting unit refers to a polymer portion corresponding to a monomer that accounts for 40 mol % or greater of the total raw materials forming the polymer.

The above 2) conjugated diene polymers and 3) acrylic polymers may be obtained by copolymerizing these with additional copolymerizable monomers. Examples of the additional copolymerizable monomer used include unsaturated carboxylic acid alkyl esters, aromatic vinyl-based monomers, vinyl cyanide-based monomers, unsaturated monomers containing a hydroxyalkyl group, unsaturated carboxylic acid amide monomers, crotonic acid, maleic acid, maleic anhydride, fumaric acid, and itaconic acid. These may be used alone or in combination of two or more. Of the above, unsaturated carboxylic acid alkyl ester monomers are particularly preferable. Examples of the unsaturated carboxylic acid alkyl ester monomer include dimethyl fumarate, diethyl fumarate, dimethyl maleate, diethyl maleate, dimethyl itaconate, monomethyl fumarate, and monoethyl fumarate. These may be used alone or in a combination of two or more.

The above 2) conjugated diene polymers may be obtained by copolymerizing with the above (meth)acrylic compound as the additional monomer.

The binder polymer is preferably in the form of a latex, more preferably a latex of an acrylic polymer, from the viewpoints of having a strong binding force between a plurality of inorganic particles even at high temperature exceeding room temperature and inhibiting heat shrinkage.

A dispersant such as a surfactant may be added to a coating solution for forming the inorganic porous layer to improve dispersion stabilization and coatability. The dispersant is adsorbed on surfaces of the inorganic particles in a slurry and stabilizes the inorganic particles by electrostatic repulsion, and is, for example, a polycarboxylate, a sulfonate, or a polyoxyether. The addition amount of the dispersant in terms of solid content is preferably 0.2 parts by weight or more and 5.0 parts by weight or less, and more preferably 0.3 parts by weight or more and 1.0 parts by weight or less.

The total thickness of the inorganic porous layer is preferably 0.1 μm to 10 μm, more preferably 0.2 μm to 7 μm, and even more preferably 0.3 μm to 4 μm. The total thickness of the inorganic porous layer indicates a thickness of an inorganic porous layer when formed on one side of the polyolefin microporous membrane, and a total of thicknesses of both inorganic porous layers when formed on both sides of the PO microporous membrane. It is preferable that the total thickness of the inorganic porous layer be 0.1 μm or more from the viewpoint of inhibiting deformation at temperatures exceeding the melting point of the polyolefin microporous membrane, and it is preferable that the total thickness be 10 μm or less from the viewpoint of improving cell capacity.

### (Thermoplastic Resin Layer)

The thermoplastic resin layer is a layer comprising a thermoplastic resin as a main component, and may optionally comprise additional components. From the viewpoint of high adhesive property, it is preferable that the polyolefin microporous membrane be in direct contact with the thermoplastic resin layer.

The ratio of the thermoplastic resin in the thermoplastic resin layer, from the viewpoint of adhesive property to an electrode, is preferably greater than 3% by weight, more preferably 10% by weight or greater, even more preferably 20% by weight or greater, 40% by weight or greater, 60% by weight or greater, or 80% by weight or greater, and particularly preferably 90% by weight or greater.

Examples of the thermoplastic resin include the specific examples of the binder polymer contained in the inorganic porous layer above. Of those, from the viewpoint of adhesive property and the viewpoint of safety during a nail penetration test of the nonaqueous secondary cell or a short circuit, 2) conjugated diene polymers, 3) acrylic polymers, 5) fluorine-containing resins, and 7) polyamides as polymers are preferable.

The area ratio of the thermoplastic resin layer to the entire area of the surface of the polyolefin microporous membrane is preferably 100% or less, 95% or less, 80% or less, 75% or less, or 70% or less. In addition, the area ratio is preferably 5% or greater, 10% or greater, or 15% or greater. It is preferable that the area ratio be set to 100% or less from the viewpoints of inhibiting clogging of pores in the polyolefin microporous membrane by the thermoplastic resin and further improving permeability of a separator. It is preferable that the area ratio be set to 5% or greater from the viewpoint of further improving adhesive property to an electrode.

When the thermoplastic resin layer is arranged on a portion of the polyolefin microporous membrane or the inorganic porous layer, examples of the arrangement pattern of the thermoplastic resin layer includes dots, oblique lines, stripes, lattice, bands, carapace, random, and combinations thereof.

The thickness of the thermoplastic resin layer is preferably 0.1 μm or more, more preferably 0.2 μm or more, and even more preferably 0.3 μm or more, and is preferably 10 μm or less, more preferably 7 μm or less, and even more preferably 4 μm or less per side of the polyolefin microporous membrane. It is preferable that the thickness of the thermoplastic resin layer be set to 0.1 μm or more from the viewpoint of exhibiting a uniform adhesive force between an electrode and the multilayer porous membrane, and as a result, cell characteristics can be improved. It is preferable that the thickness of the thermoplastic resin layer be set to 10 μm or less from the viewpoint of inhibiting a decrease in ion permeability.

### (Multifunctional Layer)

The multifunctional layer is a layer that imparts a plurality of functions to the polyolefin microporous membrane or the separator, and for example, can have the functions of both the inorganic porous layer and the thermoplastic resin layer. More specifically, the multifunctional layer, as described above, comprises a binder polymer or thermoplastic resin and inorganic particles, and may optionally comprise additional components such as a dispersant. The thickness of the multifunctional layer is not particularly limited, and can be determined according to the function imparted to the polyolefin microporous membrane and the application conditions.

### <Manufacturing Method of Polyolefin Microporous Membrane>

The manufacturing method of the polyolefin microporous membrane according to the present invention is not particularly limited. One example of the method comprises the following steps:
(A) extruding a polyolefin composition comprising a polyolefin resin and a pore-forming material to form a gel-like sheet;
(B) stretching the gel-like sheet biaxially to form a stretched sheet;
(C) extracting the pore-forming material from the stretched sheet to form a porous membrane; and
(D) heat setting the porous membrane.

The manufacturing steps of the polyolefin microporous membrane and preferred embodiments thereof will be described below.

### [Extrusion Step (A)]

In step (A), a polyolefin composition is extruded to form a gel-like sheet. The polyolefin composition may comprise a polyolefin resin and a pore-forming agent. It is preferable that the resin contained in the polyolefin composition consist only of polyolefin without containing any non-resin components such as fine particles or highly heat-resistant resins having significantly different melting points, from the viewpoints of uniformizing stretching stresses and improving air permeability and air permeability distribution of the resulting membrane. The gel-like sheet can be obtained by melt-kneading the polyolefin resin and the pore-forming agent together to form a sheet.

First, the polyolefin resin is melt-kneaded with the pore-forming agent. Examples of the melt-kneading method include a kneading method in which the polyolefin resin and, if necessary, additional additives are charged in a resin kneading apparatus such as an extruder, a kneader, a Labo-Plastomill, a kneading roll, or a Banbury mixer, and the resin component is heated to melting while the pore-forming material is introduced at any ratio.

The polyolefin resin contained in the polyolefin composition can be determined in accordance with a predetermined resin raw material of the resulting polyolefin microporous membrane. Specifically, the polyolefin resin used in the extrusion step (A) may be a polyolefin resin described as a component of the polyolefin microporous membrane according to embodiments 1 to 4.

The lower limit value of the content of a plasticizer in the resin composition is preferably 66% by weight or greater, more preferably 70% by weight or greater, and even more preferably 73% by weight or greater, and the upper limit value thereof is preferably 90% by weight or less, and more preferably 80% by weight or less. By adjusting the content of the plasticizer to 66% by weight or greater, melt viscosity of the resin composition is decreased, melt fracture is inhibited, and membrane formability during extrusion tends to improve. By adjusting the content of the plasticizer to 90% by weight or less, original cloth elongation during the membrane production step can be inhibited.

The Mv lower limit value of at least one raw material of the high molecular weight raw materials contained in the polyolefin composition, from the viewpoint of adjusting the molecular weight, MI, puncture strength, basis weight equivalent puncture strength, air permeability and porosity before compression, withstand voltage reduction rate due to pressing, and heat shrinkage rate of the resulting microporous membrane to within the numerical ranges described above, is preferably 700,000 or greater, and the Mv upper limit value may be, for example, 2,000,000 or less. From the same viewpoint, the ratio of high molecular weight raw materials having a Mv of 700,000 or greater of the resin contained in the poly olefin composition is preferably 50% by weight or greater, more preferably 60% by weight or greater, even more preferably 70% by weight or greater, and particularly preferably 80% by weight or greater, and may be 100% by weight.

When a polyolefin composition comprises polyethylene as a main component, the Mv of polyethylene, from the viewpoint of adjusting the withstand voltage reduction rate due to pressing or crystal structure characteristic value of the resulting microporous membrane to within the numerical ranges described above, is preferably 500,000 or greater, more preferably 600,000 or greater, even more preferably 700,000 or greater, and still more preferably 800,000 or greater. The Mv upper limit value of polyethylene may be, for example, 2,000,000 or less. From the same viewpoint, the ratio of polyethylene have a Mv of 700,000 or greater of the polyolefin resin constituting the polyolefin resin porous membrane is preferably 50% by weight or greater, more preferably 60% by weight or greater, even more preferably 70% by weight or greater, and particularly preferably 80% by weight or greater, and may be 100% by weight.

From the viewpoint of heat resistance of the resulting microporous membrane, polypropylene may be blended in the polyolefin composition. In this case, the ratio of polypropylene relative to the total polyolefin resin in the polyolefin composition, from the viewpoint of membrane strength and compression resistance, is preferably 1% by weight or greater and 20% by weight or less, more preferably 2% by weight or greater and 15% by weight or less, and even more preferably 2% by weight or greater and 10% by weight or less. From the viewpoint of improving moldability, the ratio of polypropylene relative to the total polyolefin resin in the polyolefin composition is preferably 3% by weight or greater and 10% by weight or less, and more preferably 5% by weight or greater and 9% by weight or less.

Examples of the pore-forming material can include plasticizers, inorganic materials, and combinations thereof.

The plasticizer is not particularly limited. However, it is preferable to use a non-volatile solvent capable of forming a uniform solution above the melting point of the polyolefin. Specific examples of the non-volatile solvent include hydrocarbons such as liquid paraffin and paraffin wax; esters such as dioctyl butyrate and dibutyl butyrate; and higher alcohols such as oleyl alcohol and stearyl alcohol. After extraction, these plasticizers may be recovered for reuse by an operation such as distillation.

Of the plasticizers, liquid paraffin is preferable when the polyolefin resin is polyethylene or polypropylene, since liquid paraffin has high compatibility therewith, the interfacial peeling between the resin and the plasticizer is not likely to occur even when the melt-kneaded product is stretched, and uniform stretching tends to be easy to carry out.

Examples of the inorganic material include, but are not particularly limited to, oxide-based ceramics such as alumina, silica (silicon oxide), titania, zirconia, magnesia, ceria, yttria, zinc oxide, and iron oxide; nitride-based ceramics such as silicon nitride, titanium nitride, and boron nitride; ceramics such as silicon carbide, calcium carbonate, aluminum sulfate, aluminum hydroxide, potassium titanate, talc, kaolin clay, kaolinite, halloysite, pyrophyllite, montmorillonite, sericite, mica, amesite, bentonite, asbestos, zeolite, calcium silicate, magnesium silicate, diatomite, and quartz sand; and glass fibers. These can be used alone or in combination of two or more. Of these, silica is particularly preferable from the ease of extraction.

The ratio of the polyolefin resin composition to the inorganic material is preferably 3% by weight or greater of the inorganic material, more preferably 10% by weight or greater, with respect to the total weight thereof from the viewpoint of obtaining satisfactory isolation. From the viewpoint of ensuring high strength, the ratio is preferably 60% by weight or less, and more preferably 50% by weight or less.

Next, the melt-kneaded product is formed into a sheet to obtain a gel-like sheet. When melt-kneading is carried out by an extruder, the ratio (Q/N, unit: kg/(h·rpm)) of the extrusion rate (i.e., the discharge amount Q of the extruder: kg/h) to the screw rotational speed N (rpm) of the extruder is preferably 0.1 or greater and 7.0 or less, more preferably 0.5 or greater and 6.0 or less, and even more preferably 1.0 or greater and 5.0 or less. When the melt-kneading is carried out under the condition of Q/N of 0.1 or greater and less than 7.0, the liquid paraffin phase-separated from the resin disperses more easily, and thus the pore structure becomes denser and the strength tends to be increased.

Examples of the method of producing the gel-like sheet include a solidifying method in which a melt-kneaded product is extruded through a T-die into a sheet, brought into contact with a thermal conductor, and cooled to a temperature sufficiently lower than the crystallization temperature of the resin component. Examples of the thermal conductor used for cooling and solidification include a metal, water, air, and a plasticizer. Of these, it is preferable to use a metal roll because of high thermal conducting efficiency. In addition, it is more preferable that the extruded gel-like sheet be interposed between rolls when brought into contact with the metal roll, which tends to further increase thermal conducting efficiency, align the sheet to increase membrane strength, and improve the surface smoothness of the sheet.

From the viewpoint of controlling cast clearance when the melt-kneaded product is extruded into a sheet from the T-die to adjust the average film thickness (before compression) of the resulting microporous membrane to within the numerical range described above, for example, the cast rolls have a roll-to-roll distance of preferably 200 μm or more and 3,000 μm or less, and more preferably 500 μm or more and 2,500 μm or less. When the roll-to-roll distance between cast rolls is 200 μm or more, the risk of membrane rupture in a subsequent stretching step can be reduced. When the roll-to-roll distance is 3,000 μm or less, cooling rate is high and uneven cooling can be prevented. From the viewpoints of obtaining a thin film and increasing plane orientation and crystallinity to achieve a stretch ratio necessary to improve compressibility, the cast thickness is preferably 500 μm to 2200 μm, and more preferably 700 μm to 2000 μm.

The extruded sheet-like molded body or gel-like sheet may be rolled. Rolling may be carried out by, for example, a method using rolls. Particularly, orientation of the surface layer portion can be increased by rolling. The rolling surface ratio is preferably greater than 1 and 3 or less, more preferably greater than 1 and 2 or less. When the rolling ratio is greater than 1, surface orientation increases, and the ultimately obtained microporous membrane tends to have increased membrane strength. When the rolling ratio is 3 or less, the difference in orientation between the surface layer portion and the center interior portion is small, and a uniform porous structure tends to be formed in the thickness direction of the membrane.

### [Biaxial Stretching Step (B)]

In step (B), the gel-like sheet obtained in the step (A) is stretched. The step (B) is carried out before step (C) of extracting the pore-forming material from the sheet. The process of stretching the gel-like sheet in the step (B) is carried out at least once each in the longitudinal direction and the width direction (i.e., by biaxial stretching), from the viewpoint of controlling the flexural rigidity of the polyolefin microporous membrane.

Examples of the stretching method can include methods such as simultaneous biaxial stretching, sequential biaxial stretching, multistage stretching, and multiple stretching. Of these, from the viewpoints of improvement of membrane strength, control of MD/TD tensile strength ratio, and uniformity in stretching and the viewpoint that the trunk structure tends to be isotropic in the plane and stress is isotropically dispersed during pressing, thereby improving safety in nail penetration tests and cycle characteristics, simultaneous biaxial stretching is preferable. Simultaneous biaxial stretching refers to a stretching method for carrying out MD stretching and TD stretching simultaneously, and the stretch ratio in each direction may be different. Sequential biaxial stretching refers to a stretching method for carrying out stretching in the MD and TD independently, and while stretching is carried out in the MD or TD, an unconstrained state or a fixed length state is maintained in the other direction.

In the MD stretching of the step (B), from the viewpoint of adjusting the withstand voltage reduction rate due to pressing of the resulting microporous membrane, crystal structure characteristic values before and after pressing, porosity before compression, puncture strength, or basis weight equivalent puncture strength to within the numerical ranges described above and the viewpoint of highly orienting polyethylene as a main component to form a highly rigid trunk, the lower limit value of the MD stretch ratio is preferably 6 or greater, more preferably 6.3 or greater, and even more preferably 7 or greater, and the upper limit value thereof is preferably 15 or less, more preferably 12 or less, even more preferably 10 or less, and particularly preferably 8 or less. The MD stretch ratio can be adjusted according to, for example, the MD stretching temperature, MD stretching wind speed, MD stretching time, and MD stretching coefficient.

In the TD stretching of the step (B), from the viewpoint of adjusting the withstand voltage reduction rate due to pressing of the resulting microporous membrane, crystal structure characteristic values before and after pressing, porosity before compression, puncture strength, or basis weight equivalent puncture strength to within the numerical ranges described above and the viewpoint of highly orienting polyethylene as a main component to form a highly rigid trunk, the lower limit value of the TD stretch ratio is preferably 6 or greater, more preferably 6.3 or greater, and even more preferably 7 or greater, and the upper limit value thereof is preferably 15 or less, more preferably 12 or less, even more preferably 10 or less, and particularly preferably 8 or less. The TD stretch ratio can be adjusted according to, for example, the TD stretching temperature, TD stretching wind speed, TD stretching time, and TD stretching coefficient.

From the same viewpoint as the MD or TD stretch ratio, and the viewpoint of adjusting the dynamic friction coefficients on one or both sides of the polyolefin microporous membrane and the average value thereof to within the numerical ranges described above, the lower limit value of the MD or TD stretching temperature is preferably 120.0° C. or higher, more preferably 120.5° C. or higher, and even more preferably 121.0° C. or higher, and the upper limit value thereof is preferably 130.0° C. or lower, more preferably 128.0° C. or lower, and even more preferably 126.0° C. or lower. Of these, it is particularly preferable that the TD stretching temperature, biaxial stretching temperature, or simultaneous biaxial stretching temperature be within the above numerical range. The stretching temperature in the step (B) can be adjusted according to, for example, MD or TD stretching wind speed, MD or TD stretching time, or MD or TD stretching coefficient.

In the step (B), from the viewpoint of adjusting physical property values of the resulting microporous membrane to within the numerical ranges described above, the biaxial stretch ratio is preferably 5×5 or greater, more preferably 5×5 or greater and 10×10 or less, and even more preferably 6×6 or greater and 10×10 or less. From the same viewpoint, the biaxial stretch ratio is preferably a simultaneous biaxial stretch ratio.

### [Extraction Step (C)]

In step (C), the pore-forming material is removed from the sheet-like molded body to obtain a porous membrane. Examples of the method to remove the pore-forming material include a method in which the sheet-like molded body is immersed in an extraction solvent to extract the pore-forming material and sufficiently dried. The extraction method of the pore-forming material may be a batch type or a continuous type. In order to inhibit the shrinkage of the microporous membrane, it is preferable that the end portion of the sheet-like molded body be restrained in the series of immersion and drying steps. The remaining amount of the pore-forming material in the microporous membrane is preferably less than 1% by weight with respect to the weight of the entire porous membrane.

The extraction solvent used when extracting the pore-forming material is preferably one that is a poor solvent of the polyolefin resin, is a good solvent of the pore-forming material, and has a boiling point lower than the melting point of the polyolefin resin. Examples of such an extraction solvent include hydrocarbons such as n-hexane and cyclohexane; halogenated hydrocarbons such as methylene chloride and 1,1,1-trichloroethane; non-chlorine-based halogenated solvents such as hydrofluoroethers and hydrofluorocarbons; alcohols such as ethanol and isopropanol; ethers such as diethyl ether and tetrahydrofuran; and ketones such as acetone and methyl ethyl ketone. These extraction solvents may be recovered for reuse by an operation such as distillation. When an inorganic material is used as the pore-forming material, an aqueous solution of, for example, sodium hydroxide or potassium hydroxide can be used as the extraction solvent.

### [Heat Setting Step (D)]

In the heat setting step (D), the polyolefin microporous membrane is heat-treated for the purpose of heat setting (HS) after the plasticizer extraction in the step (C) to inhibit shrinkage of the microporous membrane. Examples of the heat treatment of the microporous membrane include a stretching operation carried out in an atmosphere of a predetermined temperature and a predetermined stretch ratio for the purpose of adjusting physical properties, and/or a relaxation operation carried out in an atmosphere of a predetermined temperature and a predetermined relaxation rate for the purpose of reducing stretching stress. The relaxation operation is a contraction operation of the membrane after the stretching operation. The heat treatments can be carried out using a tenter or a roll stretcher. Additionally, the heat setting comprising the stretching and relaxation operations after plasticizer extraction is preferably carried out in the TD.

Optionally, in the step (D), the polyolefin microporous membrane may be delivered to a preheating furnace or subject to preheating before stretching of the microporous membrane. From the viewpoint of HS stretching while preventing membrane rupture, the lower limit value of the HS preheating temperature is preferably 100° C. or higher, more preferably 105° C. or higher, even more preferably 110° C. or higher, and particularly preferably 115° C. or higher, and the upper limit value thereof is preferably 140° C. or lower, more preferably 135° C. or lower, and 130° C. or lower.

The preheating coefficient in HS is a value obtained by multiplying the preheating temperature by the preheating wind speed and the residence time (hereinafter referred to as “preheating residence time”) of the membrane during preheating. From the same viewpoint as the HS preheating temperature, the lower limit value thereof is preferably 500° C.·m or less, more preferably 1000° C.·m or less, even more preferably 1500° C.·m or less, and particularly preferably 2000° C.·m or less. The upper limit value thereof is preferably 10000° C.·m or less, more preferably 8000° C.·m or less, and even more preferably 6000° C.·m or less. From the viewpoint of control of the ratio (preheating coefficient/heat setting coefficient) of the preheating coefficient relative to the heat setting coefficient in a heat setting furnace during the HS step, the lower limit value of the preheating residence time is preferably 1 second (s) or more, and/or the upper limit value of the preheating residence time is preferably 10 seconds (s) or less, and more preferably 8 seconds (s) or less. From the same viewpoint as the preheating residence time, the lower limit value of the preheating wind speed is preferably 1 m/s or more, and/or the upper limit value of the preheating wind speed is preferably 8 m/s or less, and more preferably 6 m/s or less. When the preheating furnace is separated into a plurality of chambers having different wind speeds, the preheating coefficient as the wind speed of the entire preheating furnace is calculated from the result of “wind speed of each chamber×furnace length of each chamber/furnace length of entire preheating furnace”.

The TD stretching operation in the step (D) is carried out at a TD stretching temperature of preferably 130° C. or higher and 150° C. or lower, more preferably 132° C. or higher and 145° C. or lower, and even more preferably 133° C. or higher and 140° C. or lower, whereby the withstand voltage reduction rate due to pressing of the resulting microporous membrane, crystal structure characteristic values before and after pressing, porosity before compression, and dynamic friction coefficients of one or both sides and the average value thereof are easily adjusted to within the numerical ranges described above.

From the viewpoint of crystallizing polyethylene, which is a main component of the microporous membrane, to form a highly rigid trunk and the viewpoint of adjusting physical property values of the resulting microporous membrane to within the numerical ranges described above, the lower limit value of the heat setting ratio, i.e., post-relaxation ratio in the step (D) is preferably 1.4 or greater, and more preferably 1.5 or greater, and the upper limit value thereof is preferably 2.5 or less, more preferably 2.0 or less, even more preferably 1.9 or less, still more preferably 1.8 or less, and particularly preferably 1.7 or less.

From the viewpoint of crystallizing polyethylene, which is a main component of the microporous membrane, to form a highly rigid trunk and the viewpoint of adjusting physical property values of the resulting microporous membrane to within the numerical values described above, the lower limit value of the heat setting temperature, i.e., relaxation temperature in the step (D) is preferably 130° C. or higher, more preferably 131° C. or higher, and even more preferably 132° C. or higher, and the upper limit value is preferably 140° C. or lower, more preferably 138° C. or lower, and even more preferably 136° C. or lower.

In the step (D), from the viewpoint of reducing crystal change due to pressing of the resulting polyolefin microporous membrane to inhibit withstand voltage reduction, it is preferable that the microporous membrane not be subjected to preheating in a heat setting furnace, or it is preferable that the ratio (preheating coefficient/heat setting coefficient) of the preheating coefficient relative to the heat setting coefficient in a heat setting furnace be controlled to a constant value or less. In the step (D), from the viewpoint of adjusting the withstand voltage reduction rate due to pressing of the resulting microporous membrane, crystal structure characteristic values before and after pressing, and dynamic friction coefficients of one or both sides of the microporous membrane and the average value thereof to within the numerical ranges described above, the upper limit value of the ratio (preheating coefficient/heat setting coefficient) in a heat setting furnace is preferably 0.5 or less, more preferably 0.45 or less, even more preferably 0.4 or less, and particularly preferably 0.35 or less. The lower limit value thereof is preferably 0.01 or greater, more preferably 0.05 or greater, even more preferably 0.10 or greater, still more preferably 0.20 or greater, and particularly preferably 0.25 or greater.

The heat setting coefficient in a heat setting furnace is a value obtained by multiplying the heat setting temperature by the heat setting wind speed and the residence time (hereinafter referred to as “heat setting residence time”) of the membrane during the heat setting step. From the viewpoint of reducing crystal change due to pressing of the resulting polyolefin microporous membrane to inhibit withstand voltage reduction and the viewpoint of controlling the ratio (preheating coefficient/heat setting coefficient) in a heat setting furnace, the lower limit value of the heat setting coefficient is preferably 3000° C.·m or more, more preferably 5000° C.·m or more, and even more preferably 6000° C.·m or more, and the upper limit value of the heat setting coefficient is preferably 30000° C.·m or less, more preferably 20000° C.·m or less, even more preferably 15000° C.·m or less, and particularly preferably 12000° C.·m or less. From the viewpoint of control of the ratio (preheating coefficient/heat setting coefficient) in a heat setting furnace during the HS step, the lower limit value of the heat setting residence time is preferably 1 second (s) or more, and/or the upper limit value of the heat setting residence time is preferably 15 seconds (s) or less, and more preferably 12 seconds (s) or less. From the same viewpoint of the heat setting residence time, the lower limit value of the heat setting wind speed is preferably 1 m/s or more, and more preferably 6 m/s or more, and/or the upper limit value of the heat setting wind speed is preferably 15 m/s or less, and more preferably 12 m/s or less. When the heat setting furnace is separated into a plurality of chambers having different wind speeds, the wind speed as the wind speed of the entire heat setting furnace and the heat setting coefficient are calculated from the result of “wind speed of each chamber×furnace length of each chamber/furnace length of entire heat setting furnace”. The heat setting residence time is calculated from the furnace length of the entire heat setting furnace/the average speed of the entire heat setting furnace. The heat setting furnace length is the distance from the point where lateral stretching and relaxation operation is initiated to the end of the heat setting furnace.

The polyolefin microporous membranes according to Embodiments 1 to 4 can be obtained by a manufacturing method comprising the steps (A) to (D). The total stretch ratio of the ultimately obtained polyolefin microporous membrane is preferably 60 or greater and 200 or less, more preferably 65 or greater and 150 or less, and even more preferably 70 or greater and 100 or less in order to crystallize polyethylene, which is a main component of the microporous membrane, to form a highly rigid trunk.

### <Manufacturing Method of Multilayer Porous Membrane>

The manufacturing method of a multilayer porous membrane according to one embodiment of the present invention is not particularly limited. As one example, the method can comprise a step of arranging at least one layer selected from the group consisting of a multifunctional layer, an inorganic porous layer, and a thermoplastic resin layer on at least one side of the polyolefin microporous membrane manufactured above.

Examples of the method of arranging a multifunctional layer, an inorganic porous layer, or a thermoplastic resin layer include, but are not particularly limited to, a method in which a coating solution comprising components of any of these layers is applied on one or both sides of the polyolefin microporous membrane or on a layer formed on the polyolefin microporous membrane. The thickness of the coating layer is preferably 0.1 to 10 μm, more preferably 0.2 to 7 μm, and even more preferably 0.3 to 4 μm. The number of coating layers is preferably 0 to 5 layers, and more preferably 0 to 3 layers. By appropriately controlling the thickness of the coating layer, cell capacity can be increased. An inorganic application has an effect of inhibiting shrinkage of the substrate and improving safety of the cell, while an organic application has an effect of enhancing adhesive property to an electrode and improving processability. By blending an organic polymer component with an inorganic component, a balance of both features can be satisfactorily achieved.

The application method is not particularly limited as long as the desired application pattern, coating film thickness, and application area can be achieved. Examples thereof include gravure coater method, small-diameter gravure coater method, reverse roll coater method, transfer roll coater method, kiss coater method, dip coater method, knife coater method, air doctor coater method, blade coater method, rod coater method, squeeze coater method, cast coater method, die coater method, screen printing method, spray coating method, and inkjet coating method.

As a medium for the coating solution, water or a mixed solvent of water and a water-soluble organic medium is preferable. The water-soluble organic medium is not particularly limited. Examples thereof can include ethanol and methanol.

Prior to application, it is preferable that a surface treatment be applied to the polyolefin microporous membrane, thereby facilitating application of the coating solution and improving adhesive property between the polyolefin microporous membrane and the coating layer. Examples of the surface treatment method include corona discharge treatment, plasma treatment, mechanical surface roughening, solvent treatment, acid treatment, and ultraviolet oxidation.

After application, the solvent may be removed from the coating film by drying at a temperature below or equal to the melting point of the polyolefin microporous membrane, reduced-pressure drying, or solvent extraction.

Alternatively, the polyolefin microporous membrane and at least one layer selected from the group consisting of a multifunctional layer, an inorganic porous layer, and a thermoplastic resin layer may be separately manufactured and then integrated by attachment, lamination, adhesion, or fusion.

### <Separator for Nonaqueous Secondary Cells and Nonaqueous Secondary Cells>

The polyolefin microporous membranes according to Embodiments 1 to 4 can be used, for example, in nonaqueous secondary cells, specifically as separators for nonaqueous secondary cells. Examples of the nonaqueous secondary cell include lithium-ion secondary cells. The polyolefin microporous membranes according to Embodiments 1 to 4, when incorporated in lithium-ion secondary cells, not only inhibit thermal runaway of the lithium ion secondary cells but can also achieve cell characteristics such as high output characteristics and high cycle characteristics and inhibition of short-circuit defects, even when comprising easily shrinkable electrodes, high-capacity electrodes, or Si-containing electrodes.

### EXAMPLES

Hereinafter, the present invention will be more specifically described with reference to the Examples and Comparative Examples, but is not limited thereto as long as the present invention does not exceed the scope thereof. Physical properties in the Examples were measured by the following methods. Unless specified otherwise, each measurement was carried out in an environment at room temperature of 23° C.±2° C. and a humidity of 40%±5%.

### [Viscosity-Average Molecular Weight]

The limiting viscosity [η] (dl/g) at 135° C. in a decalin solvent was determined based on ASTM-D4020.

For polyethylene, Mv was calculated from the following formula:

[η]=6.77×10⁻⁴ Mv^{0.67}

For polypropylene, Mv was calculated from the following formula:

[η]=1.10×10⁻⁴Mv^{0.80}

### [Weight-Average Molecular Weight and Number-Average Molecular Weight]

Standard polystyrene was measured using a Model ALC/GPC 150C™ manufactured by Waters Co. under the following conditions, and a calibration curve was drawn. The chromatogram for each polymer was also measured under the same conditions, and the weight-average molecular weight of each polymer was calculated by the following method, based on the calibration curve.
Column: GMH₆-HT™ (2)+GMH₆-HTL™ (2) manufactured by Tosoh Corporation
Mobile phase: o-dichlorobenzene
Detector: differential refractometer
Flow rate: 1.0 ml/min
Column temperature: 140° C.
Sample concentration: 0.1 wt %

### (Weight-Average Molecular Weight and Number-Average Molecular Weight of Polyethylene and Polypropylene)

Each molecular weight component in the obtained calibration curve was multiplied by 0.43 (polyethylene Q factor/polystyrene Q factor=17.7/41.3) or 0.64 (polypropylene Q factor/polystyrene Q factor=26.4/41.3) to obtain a polyethylene-equivalent or polypropylene-equivalent molecular weight distribution curve, and the weight-average molecular weight was calculated.

### (Weight-Average Molecular Weight and Number-Average Molecular Weight of Resin Composition and Resin Microporous Membrane)

The weight-average molecular weight and number-average molecular weight were calculated in the same manner as for polyethylene, except that the Q factor value for the polyolefin with the largest mass fraction was used.

### [Melt Flow Index (MI)]

The melt flow index (MI) of the microporous membrane was measured in accordance with JIS K7210:1999 (Plastics—Melt Mass Flow Rate (MFR) and Melt Volume Flow Rate (MVR) of Thermoplastics). A load of 21.6 kgf was applied to the membrane at 190° C., the amount (g) of resin that flowed out in 10 min from an orifice having a diameter of 2 mm and a length of 10 mm was measured, and the value rounded to the first decimal place was used as MI.

[Density (g/cm³)]

The density of the sample was measured by a density gradient tube method (23° C.) in accordance with JIS K7112:1999.

[Basis Weight (g/m²)]

The basis weight is the weight (g) of the polyolefin microporous membrane per unit area (1 m²). After obtaining a 1 m×1 m sample, the weight was measured with an electronic scale (AUW120D) manufactured by Shimadzu Corporation. When sampling in 1 m×1 m was not possible, a sample was cut into an appropriate area and the weight was measured. Thereafter, the weight was converted to weight (g) per unit area (1 m²).

### [Thickness (μm) of Microporous Membrane (Before Compression)]

Using a micro-thickness meter (Type KBN, tip diameter Φ 5 mm) manufactured by Toyo Seiki Seisaku-sho, Ltd., thickness was measured at an ambient temperature of 23±2° C. When measuring the thickness, a plurality of 10 cm×10 cm sheets were sampled from the microporous membrane and then stacked to 15 μm or higher. Nine points were measured and the average value was calculated. The average value divided by the number of stacked sheets was used as the thickness of one sheet.

### [Thicknesses (μm) of Multilayer Porous Membrane and Coating Layer (Before Compression)]

The thickness of the multilayer porous membrane was measured at room temperature (23±2° C.) using a micro-thickness meter “KBM™” manufactured by Toyo Seiki Seisaku-sho, Ltd., and the thickness of the coating layer was calculated from the average thickness of the microporous membrane (before compression) and the thickness of the multilayer porous membrane (before compression). From the viewpoint of detection from the multilayer porous membrane, the thickness of each layer can also be measured using a cross-sectional SEM image.

### [Porosity (%) (Before Compression)]

A 3 cm×3 cm square, 1 cm×1 cm square, 5 cm×5 cm square, or 10 cm×10 cm square sample was cut from the polyolefin microporous membrane, the volume (cm³) and mass (g) thereof were determined, and these values and the density (g/cm³) were used in the following formula:

Porosity (%)=(volume−mass/density of mixed composition)/volume×100

The density of the mixed composition is a value calculated from the densities and blending ratio of the polyolefin resin and other components.

The porosity of the multilayer porous membrane (before compression) is determined by the following formula.

Porosity of multilayer porous membrane=(porosity of polyolefin resin microporous membrane used as substrate)×(average film thickness of polyolefin resin microporous membrane used as substrate)÷(thickness of entire multilayer porous membrane)+(porosity of coating layer)×(thickness of coating layer)÷(thickness of entire multilayer porous membrane)

The porosity of the multilayer porous membrane was calculated assuming that the porosity of the coating layer was 50%. When the porosity of the coating layer is not 50%, the porosity of the coating layer can be calculated in the same manner as the above formula as the porosity of the polyolefin microporous membrane, if necessary. Specifically, in the coating film, the thickness of the coating layer was measured by direct observation with SEM or from the change in film thickness before and after application, and the volume of the coating layer sample of a specific area was determined. The porosity of the coating layer was then calculated using the mass-average density of the coating components calculated from material ratios of components of the coating layer.

[Air Permeability (Sec/100 cm³) (Before Compression)]

The air permeability was measured with an Oken-type Air Permeability Tester “EGO2” from Asahi Seiko Co., Ltd.

The measured value of air permeability is a value obtained by measuring the air permeability at a total of three points, two points inside 10% of total width from each of the edges toward the center and one point at the center, along the width direction (TD) of the membrane, and calculating the average thereof

### [Compression Test]

Compression tests were carried out using a 20-kN heater press manufactured by Sansho Industry Co., Ltd. with conditions set at 1-cycle automatic heater press, 150×150 mm, and 200° C. A cushioning material made of rubber having a thickness of 0.8 mm, a PET film having a thickness of 0.1 mm, the microporous membrane, the above PET film, and the above cushioning material were laminated in this order, the resulting laminated body was left to stand, and a compression test was carried out by applying pressure to the cushioning material surface of one side of the laminated body. The microporous membranes used were stacked in pairs and sampled at any positions within a range of up to 90 cm in the width direction. The number of plies used in the compression test was changed according to the two compression test conditions below. The microporous membrane or separator in a 5×5 cm size was sampled in a two-ply stack at 70 points before and after the compression test at any positions within a range of up to 90 cm in the width direction of the membrane, as needed. Average film thickness (average of 9 points), basis weight, and air permeability were measured before use in the press test. In addition, porosity before the compression test was calculated from the basis weight and the average film thickness.

Compression tests were carried out under the following two compression test conditions. Thereafter, a withstand voltage test was carried out.

### (Compression Test Condition 1)

Microporous membranes were pressed one at a time under conditions of a temperature of 60° C., a pressure of 3.4 MPa, and a compression time of 1 sec. The compression test was carried out as described above. Thereafter, the microporous membrane was set again in a two-ply state and used for a withstand voltage test.

### (Compression Test Condition 2)

Microporous membranes having a size of 5 cm×5 cm were pressed in pairs under conditions of a temperature of 70° C., a pressure of 8 MPa, and a compression time of 3 min. The compression test was carried out as described above. Thereafter, the microporous membrane was set in the two-ply state and used for a withstand voltage test.

### [Withstand Voltage Test]

Two 5×5 cm microporous membranes or separators before and after the compression test were stacked, sandwiched from both sides by aluminum foils (size of 4×4 cm) by aligning the center of an aluminum foil with the center of a microporous membrane or separator, and then sandwiched from both sides by electrodes attached to a “TOS9201” manufactured by Kikusui Electronics Corp. to carry out a dielectric breakdown test. Measurements were carried out under the following conditions in an environment at a temperature of 23° C. and a humidity of 40%.
A DC test was carried out by increasing the voltage from 0 V at a rate of 100 V/s, and the voltage at which “>0.5 mA, 3 s” was recorded as the dielectric breakdown voltage.
The dielectric breakdown test was carried out using a “TOS9201” manufactured by Kikusui Electronics Corp. A “WINSTAT AIR IONIZER BD-2DD” from SHISHIDO ELECTROSTATIC LTD. was used as a static eliminator.
“AlN30H” (thickness of 20 μm) was used for the aluminum foils.
As described above, the microporous membrane or separator in a two-ply stack (5×5 cm) was sampled at 70 points before and after compression at any positions within a range of up to 90 cm in the width direction of the membrane. The static eliminator was used every time before a withstand voltage test, and static electricity was eliminated before a measurement. In the withstand voltage test before compression, the sampled two-ply set was used as-is for the measurement. In the test after compression, the membranes were stacked in pairs again if pressed one at a time, and were directly used for the measurement if pressed in pairs.
Average values of the 70 points before and after the compression test were calculated. A withstand voltage reduction rate (%) was determined by calculating ((withstand voltage average before compression)−(withstand voltage average after compression))/(withstand voltage average before compression)×100.

### [Dynamic Friction Test]

For one surface (side A) and the other surface (side B) of the microporous membrane, the dynamic friction coefficient was calculated by measuring a sample having a size of MD 50 mm×TD 200 mm three times in each of the MD and TD using a KES-SE friction tester manufactured by Kato Tech Co., Ltd. under conditions of a load of 50 g and a contact area of 10×10=100 mm² (20 hard stainless steel SUS304 piano wires of 0.5 mm ϕ wound without gaps and without overlapping), a contact feed speed of 1 mm/sec, a tension of 6 kPa, a temperature of 23° C., and a humidity of 50%, and then determining the average value thereof. The average values of three measurements in the MD and TD for each of side A and side B of the microporous membrane sample are shown in the table below.

[Heat Shrinkage Rate (%) at 120° C. and 1 h]

The porous membrane as a sample was cut to 100 mm in the MD and 100 mm in the TD, 50 mm in the MD and 50 mm in the TD, or 30 mm in the MD and 30 mm in the TD for the lengths (mm) before heating, and left to stand in an oven at 120° C. for 1 h. At this time, the sample was interposed between 10 sheets of paper so that warm air did not contact the sample directly. After the sample was taken out of the oven and cooled, the lengths were measured to obtain the lengths (mm) after heating, and the heat shrinkage rate was calculated by the formula below. Measurements were made in the MD and TD, and the larger numerical value was used as the heat shrinkage rate.

Heat shrinkage rate (%)={(length before heating−length after heating)/length before heating}×100

### [Puncture Strength and Basis Weight Equivalent Puncture Strength]

Using a KES-G5™ handy compression tester manufactured by Kato Tech Co., Ltd., the microporous membrane was fixed to a sample holder having an opening diameter of 11.3 mm. Next, the center portion of the fixed microporous membrane was subjected to a puncture test using a needle tip with a radius of curvature of 0.5 mm at a puncture speed of 2 mm/sec and under an atmosphere at room temperature of 23° C. and a humidity of 40%. The puncture strength (go was measured thereby as the maximum puncture load. The measured value from the puncture test is a value obtained by measuring at a total of three points, two points inside 10% of total width from each of the edges toward the center and one point in the center, along the TD of the membrane and calculating the average value thereof.

The basis weight equivalent puncture strength is determined by the following formula.

Basis weight equivalent puncture strength [gf/(g/m²)]=puncture strength [gf]/basis weight [g/m²]

For the puncture strength and the basis weight equivalent puncture strength of a multilayer porous membrane, wherein at least one layer thereof is provided on the polyolefin microporous membrane substrate, from the viewpoint of evaluating strength of the resin and strength per basis weight, the properties of the polyolefin microporous membrane substrate were evaluated based on puncture strength and basis weight equivalent puncture strength.

### [Pore Size (Nm): Half-Dry]

The pore size (nm) was measured using a palm porometer (Porous Materials, Inc.: CFP-1500AE) in accordance with the half-dry method. A perfluoropolyester (trade name “Galwick”, surface tension of 15.6 dyn/cm) manufactured by the same company was used for the immersion liquid. For the drying and wetting curves, the applied pressure and the air permeation amount were measured. From the pressure PHD (Pa), which is the intersection of the half-curve obtained from the drying curve and the wetting curve, a mean pore size dHD (nm) was determined by the following formula and used as the pore size:

dHD=2860×γ/PHD

### [Measurement of Withstand Voltage Per Basis Weight (Before Compression)]

MD 10 cm×TD 10 cm was cut out of a center point in the width direction of the polyolefin microporous membrane, interposed between aluminum plates having a diameter of 5 mm, and measured with a withstand voltage measuring machine (TOS9201) manufactured by Kikusui Electronics Corp. For the measurement conditions, DC voltage was started from an initial voltage of 0 V, voltage was applied at a voltage increase rate of 100 V/sec, and the voltage (kV) when the current flowed at 0.2 mA was used as the withstand voltage of the microporous membrane. A total of 25 points, MD 5 points×TD 5 points, were measured at intervals of 15 mm, and the average value thereof was used as the withstand voltage measurement value. The withstand voltage per basis weight was calculated as a ratio (withstand voltage/basis weight) of basis weight relative to withstand voltage.

### [Crystal Structure Analysis]

For the crystal long period in the polyolefin microporous membrane, small-angle X-ray scattering measurement by a transmission method was carried out using NANOPIX manufactured by Rigaku Corporation. A sample was irradiated with CuKα rays, and scattering was detected by a HyPix-6000 semiconductor detector. Measurement was carried out under conditions of a sample-detector distance of 1312 nm and an output of 40 kV at 30 mA. A point focus was used for the optical system, and measurement was carried out under slit diameter conditions of 1^{st} slit: ϕ=0.55 mm, 2^{nd} slit: open, and guard slit: ϕ=0.35 mm. Note that the sample was set so that the sample surface was perpendicular to the X-ray incident direction.

For the diffraction peak-to-peak distance derived from the (110) plane and the (200) plane of the polyethylene crystal before compression was measured by XRD using an Ultima-IV X-ray diffractometer manufactured by Rigaku Corporation. The sample was irradiated with CuKα rays, and diffracted light was detected by a D/tex Ultra detector manufactured by Rigaku Corporation. Measurement was carried out under conditions of a sample-detector distance of 285 mm, an excitation voltage of 40 kV, and a current of 40 mA. A converging optical system was used as the optical system, and measurement was carried out under slit conditions of DS=½°, SS=release, and vertical slit=10 mm. Note that the sample was rotated during the measurement.

### (Crystal Long Period [Nm])

A SAXS profile I(q) was obtained by circular averaging of the X-ray scattering pattern obtained from the HyPix-6000. A linear baseline was drawn in the range of 0.1 nm⁻¹<q<0.6 nm⁻¹ in the Linear-Linear plot of the obtained one-dimensional profile I(q) and fitted using a Gaussian function. The crystal long period was calculated from the following Formula 4 with the position of the maximum intensity as the peak position qₘ derived from the crystal long period:

d=2π/qₘ Formula 4
wherein d (nm): crystal long period
   qₘ (nm⁻¹): peak position derived from lamella in SAXS profile.
      (Diffraction Peak-to-Peak Distance Derived from (110) Plane and (200) Plane of Polyethylene Crystal Before Compression)

A linear baseline was drawn in the range from 2θ=9.7° to 2θ=29.0° of the obtained XRD profile, and three peaks—an orthorhombic (110) plane diffraction peak, an orthorhombic (200) plane diffraction peak, and an amorphous peak—were separated. The (110) plane diffraction peak and the (200) plane diffraction peak were each approximated by a Voight function, and the amorphous peak was approximated by a Gaussian function. The peak position of the amorphous peak was fixed at 2θ=19.6° and the full width at half maximum was fixed at 6.3°. The peak position and full width at half maximum of each crystalline peak were not particularly fixed, and peak separation was carried out. The absolute value of the difference between the (110) plane and (200) plane diffraction peak positions obtained by peak separation was calculated as the peak-to-peak distance.

### [Tensile Strength at Break (MPa), MD/TD Tensile Strength at Break Ratio and Tensile Elongation at Break (%), and MD/TD Tensile Elongation at Break Ratio]

MD and TD samples (shape: 10 mm in width×100 mm in length) were measured using an Autograph AG-A™ tensile tester manufactured by Shimadzu Corporation, in accordance with HS K7127. The distance between chucks of the tensile tester was set to 50 mm, and Cellophane® tape (manufactured by Nitto Denko Packaging Systems Co., Ltd., trade name: N.29) was attached to one side on both end portions (25 mm each) of the sample. To prevent the sample from slipping during the test, fluororubber having a thickness of 1 mm was attached to the insides of the chucks of the tensile tester.

Measurement was carried out under conditions of a temperature of 23±2° C., a chuck pressure of 0.40 MPa, and a tensile speed of 100 mm/min.

The tensile strength at break (MPa) was determined by dividing the strength at break of the polyolefin microporous membrane by the cross-sectional area of the sample before the test. The elongation at break of the polyolefin microporous membrane was defined as the tensile elongation at break (%).

The tensile strength at break was determined for each of the MD and the TD, and the ratio (MD/TD tensile strength at break ratio) of the MD tensile strength at break to the TD tensile strength at break was calculated. Similarly, the tensile elongation at break was determined for each of the MD and the TD, and the ratio (MD/TD tensile elongation at break ratio) of the MD tensile elongation at break to the TD tensile elongation at break was calculated.

[Smoothness (sec/10 cm³)]

The smoothness of the polyolefin microporous membrane was measured in an atmosphere of a temperature of 30° C. and a humidity of 40% using a stainless steel nozzle having an inner diameter of 0.15 mm and a length of 50 mm in a Model EYO-5 air permeability and smoothness tester manufactured by Asahi Seiko Co., Ltd., in accordance with ISO 8791-5:2020. Surface smoothness was measured for each of one surface and the other surface of the polyolefin microporous membrane, and a surface smoothness average value of the one surface and the other surface was calculated as described above.

### [Cell Test]

a. Production of Positive Electrode

A lithium cobalt composite oxide LiCoO₂ as a positive electrode active material and graphite and acetylene black as conductive materials were dispersed in polyvinylidene fluoride (PVDF) and N-methyl pyrrolidone (NMP) as binders to prepare a slurry. The slurry was applied to an aluminum foil having a thickness of 15 μm as a positive electrode current collector with a die coater, dried at 130° C. for 3 min, and compression-molded with a roll press machine. The resulting molded body was slit to a width of 57.0 mm to obtain a positive electrode.

b. Production of Negative Electrode

Artificial graphite as a negative electrode active material and an ammonium salt of carboxymethyl cellulose and styrene-butadiene copolymer latex as conductive materials were dispersed in purified water to prepare a slurry. The slurry was applied to a copper foil as a negative electrode current collector with a die coater, dried at 120° C. for 3 min, and compression-molded with a roll press machine. The resulting molded body was slit to a width of 58.5 mm to obtain a negative electrode.

c. Preparation of Nonaqueous Electrolytic Solution

LiPF₆ was dissolved as a solute in a mixed solvent of ethylene carbonate to dimethyl carbonate to ethyl methyl carbonate=1:1:2 (volume ratio) so as to have a concentration of 1 mol/L to prepare a non-aqueous electrolytic solution.

d. Cell Assembly

After winding the positive electrode, the porous membrane obtained in the Examples or Comparative Examples, and the negative electrode, a wound electrode body was prepared by a conventional method and pressed with a pressing machine so as to fit into an exterior can. The number of wounds was adjusted according to the thickness of the polyolefin microporous membrane and the degree of spring-back. The outermost end portion of the obtained wound electrode body was fixed by attaching an insulating tape. A negative electrode lead was welded to a cell can and a positive electrode lead to a safety valve, and the wound electrode body was inserted into the interior of the cell can. Thereafter, 5 g of the non-aqueous electrolytic solution was charged in the cell can, and a lid was crimped to the cell can via a gasket to obtain a prismatic secondary cell having a width of 42.0 mm, a height of 63.0 mm, and a thickness of 10.5 mm. Charging was carried out for a total of 3 h by a method in which the prismatic secondary cell was charged under an atmosphere of 25° C. at a current value of 0.2 C (0.2 times current of the 1-h rate (1 C) of a rated electrical capacity) until a cell voltage of 4.2 V was reached, and the current was then throttled to maintain 4.2 V. The cell was then discharged at a current value of 0.2 C to a cell voltage of 3.0 V.

e. Output Characteristic Test (25° C.)

In an environment of 25° C., a rectangular secondary cell assembled in the same manner as d. above and selected for evaluation was charged at a constant current of 1 C until a cell voltage of 4.2 V was reached, and then charged at a constant voltage of 4.2 V for a total of 3 h. The 1 C discharge capacity and the 5 C discharge capacity of the charged cell discharged to a final voltage of 3 V were measured in a constant temperature state at 25° C., and the 5 C capacity/1 C capacity was taken as the output characteristic value. The output characteristic value was evaluated according to the following criteria:
A: Output characteristic value was 0.95 or greater.
B: Output characteristic value was 0.90 or greater and less than 0.95.
C: Output characteristic value was less than 0.90.
   f. Cycle Test (25° C.)

Using a rectangular secondary cell assembled in the same manner as d. above and selected for evaluation, a total of 100 charge/discharge cycles were carried out under cycle conditions of (i) constant current-constant voltage charging at a current amount of 0.5 C and an upper limit voltage of 4.2 V for a total of 3 h, (ii) 10-min rest, (iii) constant current discharging at a current amount of 0.5 C and a final voltage of 3.0 V, and (iv) 10-min rest. The above charging/discharging process was carried out under an atmosphere at 25° C. Thereafter, the ratio of the discharge capacity at 100^{th} cycle to the initial cell capacity X (mAh) was multiplied by 100 to determine the capacity retention rate (%). The capacity retention rate was evaluated according to the following criteria:
A: Capacity retention rate (%) was 90% or greater.
B: Capacity retention rate (%) was 88% or greater and less than 90%.
C: Capacity retention rate (%) was less than 88%.

### Example 1

(A) As shown in Table 1, the ratio of polyethylene (PE) having a My of 700,000 or greater was adjusted to obtain a raw material resin composition. Next, the raw material resin composition, liquid paraffin, and 0.1% by weight of an antioxidant were blended to obtain a polyolefin composition. The polyolefin composition was then charged in a twin-screw extruder, the polyolefin composition was melted and extruded to form a gel-like sheet, and the gel-like sheet was cooled and solidified by cast rolls.
(B) The cooled and solidified sheet was subjected to a biaxial stretching step under the conditions shown in Table 1 using a simultaneous biaxial stretcher to obtain a stretched sheet.
(C) The stretched sheet was then immersed in methylene chloride to extract and remove the liquid paraffin, and then dried to be porous.
(D) The resulting porous product was further subjected to heat setting under the conditions shown in Table 1 using a uniaxial stretcher to obtain a polyolefin microporous membrane. The total stretch ratio of the obtained polyolefin microporous membrane was 78. The obtained polyolefin microporous membrane was evaluated according to the above method. A cell comprising the polyolefin microporous membrane was also evaluated. The evaluation results are shown in Table 3.

### Examples 2 to 11, Reference Example 1, and Comparative Example 2

Except that the resin raw materials and manufacturing conditions shown in Tables 1 and 2 were used, a polyolefin microporous membrane was obtained and evaluated in the same manner as in Example 1. The evaluation results are shown in Tables 3 and 4 below.

### [Table 1]

TABLE 1

| | | | Example 1 | Example 2 | Example 3 | Example 4 | Example 5 | Example 6 |
|---|---|---|---|---|---|---|---|---|
| Raw material | Mv 250,000 PE | wt % | 0 | 0 | 0 | 0 | 0 | 30 |
| composition | Mv 700,000 PE | wt % | 100 | 100 | 100 | 100 | 100 | 0 |
| | Mv 900,000 PE | wt % | 0 | 0 | 0 | 0 | 0 | 70 |
| | PE average | ×10000 | 70 | 70 | 70 | 70 | 70 | 70 |
| | molecular weight | | | | | | | |
| | PP | wt % | 0 | 0 | 0 | 0 | 0 | 0 |
| | Plasticizer | wt % | 75 | 75 | 75 | 75 | 74 | 74 |
| Biaxial | Longitudinal stretch ratio | — | 7 | 7 | 7 | 7 | 7 | 7 |
| stretching | Transverse stretch ratio | — | 7 | 7 | 7 | 7 | 7 | 6.38 |
| | Stretching temperature | ° C. | 121 | 121 | 121 | 124 | 125 | 124 |
| | Stretching method | — | simultaneous | simultaneous | simultaneous | simultaneous | simultaneous | simultaneous |
| | | | biaxial | biaxial | biaxial | biaxial | biaxial | biaxial |
| Heat setting | Preheating temperature | ° C. | 120 | 120 | 120 | 125 | 110 | 110 |
| | Preheating residence time | s | 3 | 2 | 3 | 3 | 8 | 7 |
| | Preheating wind speed | m/s | 7 | 7 | 7 | 7 | 6 | 6 |
| | Preheating coefficient | ° C. · m | 2219 | 2105 | 2299 | 3028 | 5006 | 4562 |
| | Transverse stretching | ° C. | 131 | 130 | 132 | 130 | 110 | 110 |
| | temperature | | | | | | | |
| | Heat setting ratio | — | 1.59 | 1.59 | 1.65 | 1.59 | 1.40 | 1.47 |
| | Heat setting temperature | ° C. | 133 | 132 | 133 | 132 | 136 | 134 |
| | Heat setting | s | 8 | 10 | 10 | 13 | 7 | 7 |
| | residence time | | | | | | | |
| | Heat setting wind speed | m/s | 6 | 6 | 6 | 6 | 12 | 10 |
| | Heat setting coefficient | ° C. · m | 6937 | 7867 | 8622 | 10862 | 11100 | 9276 |
| | Preheating coefficient/heat | — | 0.32 | 0.27 | 0.27 | 0.28 | 0.45 | 0.49 |
| | setting coefficient | | | | | | | |

| | | | | | | | |
|---|---|---|---|---|---|---|---|
| Total stretch ratio | — | 78 | 78 | 81 | 78 | 69 | 66 |

| | | | Example 7 | Example 8 | Example 9 | Example 10 | Example 11 |
|---|---|---|---|---|---|---|---|
| Raw material | Mv 250,000 PE | wt % | 0 | 0 | 30 | 30 | 30 |
| composition | Mv 700,000 PE | wt % | 0 | 93 | 0 | 0 | 0 |
| | Mv 900,000 PE | wt % | 93 | 0 | 70 | 70 | 70 |
| | PE average | ×10000 | 90 | 70 | 70 | 70 | 70 |
| | molecular weight | | | | | | |
| | PP | wt % | 7 | 7 | 0 | 0 | 0 |
| | Plasticizer | wt % | 76 | 74 | 74 | 74 | 74 |
| Biaxial | Longitudinal stretch ratio | — | 7 | 7 | 7 | 7 | 7 |
| stretching | Transverse stretch ratio | — | 7 | 6.38 | 6.38 | 6.38 | 6.38 |
| | Stretching temperature | ° C. | 124 | 122 | 117 | 125 | 126 |
| | Stretching method | — | simultaneous | simultaneous | simultaneous | simultaneous | simultaneous |
| | | | biaxial | biaxial | biaxial | biaxial | biaxial |
| Heat setting | Preheating temperature | ° C. | 110 | 130 | 130 | 110 | 110 |
| | Preheating residence time | s | 8 | 2 | 3 | 7 | 7 |
| | Preheating wind speed | m/s | 6 | 7 | 7 | 6 | 6 |
| | Preheating coefficient | ° C. · m | 5143 | 2355 | 2742 | 4754 | 4754 |
| | Transverse stretching | ° C. | 110 | 130 | 130 | 110 | 110 |
| | temperature | | | | | | |
| | Heat setting ratio | — | 1.50 | 1.60 | 1.70 | 1.52 | 1.60 |
| | Heat setting temperature | ° C. | 136 | 133 | 132 | 136 | 135 |
| | Heat setting | s | 7 | 10 | 12 | 7 | 7 |
| | residence time | | | | | | |
| | Heat setting wind speed | m/s | 12 | 6 | 6 | 10 | 10 |
| | Heat setting coefficient | ° C. · m | 11445 | 8156 | 9458 | 9767 | 9717 |
| | Preheating coefficient/heat | — | 0.45 | 0.29 | 0.29 | 0.49 | 0.49 |
| | setting coefficient | | | | | | |

| | | | | | | |
|---|---|---|---|---|---|---|
| Total stretch ratio | — | 74 | 71 | 74 | 68 | 71 |

TABLE 2

| | | | Comparative | Comparative |
|---|---|---|---|---|
| | | | Example 1 | Example 2 |
| Raw material | Mv 250,000 PE | wt % | 47.5 | 23 |
| composition | Mv 700,000 PE | wt % | 47.5 | 70 |
| | Mv 900,000 PE | wt % | 0 | 0 |
| | PE average molecular weight | x10000 | 48 | 55 |
| | PP | wt % | 5 | 7 |
| | Plasticizer | wt % | 67 | 71 |
| Biaxial | Longitudinal stretch ratio | — | 7 | 7 |
| stretching | Transverse stretch ratio | — | 6.38 | 6.38 |
| | Stretching temperature | ° C. | 122 | 124 |
| | Stretching method | — | simultaneous | simultaneous |
| | | | biaxial | biaxial |
| Heat setting | Preheating temperature | ° C. | 121 | 120 |
| | Preheating residence time | s | 5 | 4 |
| | Preheating wind speed | m/s | 7 | 7 |
| | Preheating coefficient | ° C. · m | 4321 | 3344 |
| | Transverse stretching temperature | ° C. | 124 | 127 |
| | Heat setting ratio | — | 1.80 | 1.58 |
| | Heat setting temperature | ° C. | 127 | 129 |
| | Heat setting residence time | s | 11 | 9 |
| | Heat setting wind speed | m/s | 6 | 6 |
| | Heat setting coefficient | ° C. · m | 8306 | 6583 |
| | Preheating coefficient/heat | — | 0.52 | 0.51 |
| | setting coefficient | | | |

| | | | |
|---|---|---|---|
| Total stretch ratio | — | 80 | 71 |

TABLE 3

| | | Example 1 | Example 2 | Example 3 | Example 4 | Example 5 | Example 6 |
|---|---|---|---|---|---|---|---|
| Withstand voltage reduction rate due to | % | 15.3 | 15.3 | 15.0 | 14.4 | 5.9 | 5.6 |
| pressing at 60° C., 3.4 MPa and 1 s | | | | | | | |
| Withstand voltage reduction rate due to | % | — | — | — | — | — | — |
| pressing at 70° C., 8 MPa and 1 s | | | | | | | |
| Crystal long period | nm | 35.7 | 35.0 | 35.5 | 35.9 | 39.3 | 35.7 |
| Peak-to-peak distance of PE (200), (110) | ° | 2.421 | 2.422 | 2.424 | 2.421 | 2.424 | 2.418 |
| Porosity | % | 45.9 | 48.4 | 46.9 | 48.8 | 45.8 | 48.7 |
| Basis weight equivalent puncture strength | gf/(g/m²) | 77 | 73 | 86 | 60 | 70 | 99 |
| Dynamic friction coefficient (average of | — | 0.26 | 0.27 | 0.28 | 0.26 | 0.24 | 0.33 |
| both sides) | | | | | | | |
| Membrane MI (melt index) | g/10 min | 0.21 | 0.21 | 0.21 | 0.21 | 0.21 | 0.15 |
| | @ 190° | | | | | | |
| | C. | | | | | | |
| Tensile strength ratio | — | 1.0 | 1.0 | 0.9 | 1.1 | 0.7 | 0.9 |
| Cycle characteristics | — | B | B | A | B | B | A |
| Output characteristics | — | A | A | A | B | A | A |
| Film thickness | μm | 9.1 | 9.2 | 9.1 | 12.3 | 10.3 | 10.0 |
| Air permeability | s/100 cm³ | 90 | 80 | 90 | 88 | 90 | 87 |
| Puncture strength | gf | 360 | 330 | 395 | 360 | 370 | 480 |
| Withstand voltage (before compression) | kV | 2.39 | 2.38 | 2.51 | 2.84 | 2.55 | 2.49 |
| Pore size (half-dry) | nm | 47 | 47 | 45 | 55 | 48 | 41 |
| Side A friction coefficient average | — | 0.27 | 0.28 | 0.28 | 0.26 | 0.24 | 0.32 |
| Side B friction coefficient average | — | 0.26 | 0.27 | 0.29 | 0.27 | 0.24 | 0.34 |
| Smoothness | — | 125525 | 126775 | 155540 | 72670 | 73145 | 126935 |
| Heat shrinkage rate (120° C. MD) | % | 11 | 11 | 11 | 8 | 10 | 17 |
| Heat shrinkage rate (120° C. TD) | % | 10 | 10 | 10 | 7 | 9 | 16 |

| | | Example 7 | Example 8 | Example 9 | Example 10 | Example 11 |
|---|---|---|---|---|---|---|
| Withstand voltage reduction rate due to | % | 5.4 | 11.3 | 13.0 | 5.3 | 7.7 |
| pressing at 60° C., 3.4 MPa and 1 s | | | | | | |
| Withstand voltage reduction rate due to | % | — | 19.6 | — | 25.4 | — |
| pressing at 70° C., 8 MPa and 1 s | | | | | | |
| Crystal long period | nm | 39.4 | 34.4 | 36.6 | 38.6 | 38.2 |
| Peak-to-peak distance of PE (200), (110) | ° | 2.426 | 2.422 | 2.417 | 2.430 | 2.428 |
| Porosity | % | 49.2 | 46.0 | 47.1 | 48.3 | 49.0 |
| Basis weight equivalent puncture strength | gf/(g/m²) | 93 | 56 | 105 | 80 | 65 |
| Dynamic friction coefficient (average of | — | 0.42 | 0.43 | 0.35 | 0.26 | 0.26 |
| both sides) | | | | | | |
| Membrane MI (melt index) | g/10 min | 0.11 | 0.25 | 0.15 | 0.15 | 0.15 |
| | @ 190° | | | | | |
| | C. | | | | | |
| Tensile strength ratio | — | 0.9 | 1.4 | 0.8 | 0.9 | 0.9 |
| Cycle characteristics | — | A | B | A | A | B |
| Output characteristics | — | A | B | A | A | A |
| Film thickness | μm | 10.3 | 8.9 | 9.4 | 10.1 | 10.6 |
| Air permeability | s/100 cm³ | 87 | 85 | 96 | 84 | 78 |
| Puncture strength | gf | 462 | 250 | 500 | 400 | 342 |
| Withstand voltage (before compression) | kV | 2.70 | 2.12 | 2.70 | 2.41 | 2.46 |
| Pore size (half-dry) | nm | 48 | 56 | 46 | 48 | 52 |
| Side A friction coefficient average | — | 0.43 | 0.43 | 0.35 | 0.25 | 0.26 |
| Side B friction coefficient average | — | 0.41 | 0.43 | 0.36 | 0.26 | 0.25 |
| Smoothness | — | 103185 | 86500 | 176010 | 79590 | 66875 |
| Heat shrinkage rate (120° C. MD) | % | 10 | 7 | 14 | 7 | 8 |
| Heat shrinkage rate (120° C. TD) | % | 14 | 10 | 11 | 10 | 6 |

TABLE 4

| | | Comparative | Comparative |
|---|---|---|---|
| | | Example 1 | Example 2 |
| Withstand voltage reduction rate due to | % | 21.4 | 17.1 |
| pressing at 60° C., 3.4 MPa and 1 s | | | |
| Withstand voltage reduction rate due to | % | — | 29.5 |
| pressing at 70° C., 8 MPa and 1 s | | | |
| Crystal long period | nm | 32.1 | 34.4 |
| Peak-to-peak distance of PE (200), (110) | ° | 2.432 | 2.418 |
| Porosity | % | 56.7 | 47.3 |
| Basis weight equivalent puncture strength | gf/(g/m²) | 81 | 50 |
| Dynamic friction coefficient (average of | — | 0.73 | 0.31 |
| both sides) | | | |
| Membrane MI (melt index) | g/10 min @ | 0.74 | 0.41 |
| | 190° C. | | |
| Tensile strength ratio | — | 0.8 | 1.1 |
| Cycle characteristics | — | C | C |
| Output characteristics | — | A | C |
| Film thickness | μm | 14.7 | 10.2 |
| Air permeability | s/100 cm³ | 76 | 86 |
| Puncture strength | gf | 375 | 257 |
| Withstand voltage (before compression) | kV | 3.33 | 2.43 |
| Pore size (half-dry) | nm | 53 | 58 |
| Side A friction coefficient average | — | 0.73 | 0.28 |
| Side B friction coefficient average | — | 0.73 | 0.32 |
| Smoothness | — | 79880 | 77755 |
| Heat shrinkage rate (120° C. MD) | % | 19 | 8 |
| Heat shrinkage rate (120° C. TD) | % | 17 | 10 |

1. A polyolefin microporous membrane having a film thickness of 1 μm to 30 μm; an air permeability of 500 sec/100 cm³ or less; and a withstand voltage reduction rate of 1.0% or greater and 17.0% or less due to pressing under conditions of a temperature of 60° C., a pressure of 3.4 MPa, and a compression time of 1 sec.

2. A polyolefin microporous membrane having a film thickness of 1 μm to 30 μm; an air permeability of 500 sec/100 cm³ or less; and a withstand voltage reduction rate of 1.0% or greater and 28.0% or less due to pressing under conditions of a temperature of 70° C., a pressure of 8 MPa, and a compression time of 3 min.

3. A polyolefin microporous membrane having a polyethylene crystal long period before compression of 35.0 nm or more, measured by a small-angle X-ray scattering (SAXS) method; and a diffraction peak-to-peak distance of 2.410° or more and 2.600° or less derived from a (110) plane and a (200) plane of a polyethylene crystal before compression.

4. The polyolefin microporous membrane according to claim 1, wherein the polyolefin microporous membrane before compression has a porosity of 40% or greater and 80% or less and a basis weight equivalent puncture strength of 55 gf/(g/m²) or more and 150 gf/(g/m²) or less.

5. The polyolefin microporous membrane according to claim 1, wherein an average of dynamic friction coefficients on both surfaces of the polyolefin microporous membrane is 0.01 or greater and 0.4 or less.

6. The polyolefin microporous membrane according to claim 1, wherein the polyolefin microporous membrane has a melt flow index (MI) value of 0.01 g/10 min or more and 0.50 g/10 min or less.

7. The polyolefin microporous membrane according to claim 1, wherein a ratio (MD/TD tensile strength ratio) of a tensile strength in longitudinal direction (MD) to a tensile strength in width direction (TD) of the polyolefin microporous membrane is 0.7 to 1.3.

8. A separator comprising:
the polyolefin microporous membrane according to claim 1; and
an inorganic porous layer arranged on at least one side of the polyolefin microporous membrane.

9. A separator comprising:
the polyolefin microporous membrane according to claim 1; and
a thermoplastic resin layer arranged on at least one side of the polyolefin microporous membrane.

10. A separator comprising:
the polyolefin microporous membrane according to claim 1; and
at least one layer selected from the group consisting of a multifunctional layer, an inorganic porous layer, and a thermoplastic resin layer, arranged on at least one side of the polyolefin microporous membrane.

11. A nonaqueous secondary cell comprising the separator according to claim 8.

12. A nonaqueous secondary cell comprising the separator according to claim 9.

13. A nonaqueous secondary cell comprising the separator according to claim 10.
